(19) United States
(12) Patent Application Publication
(10) Pub. No.: US 2019/0230580 A1
(43) Pub. Date: Jul. 25, 2019

(54) METHOD AND APPARATUS FOR TRANSMITTING SETTING INFORMATION OF RESOURCE FOR CONTROL CHANNEL, METHOD AND APPARATUS FOR TRANSMITTING SETTING INFORMATION OF RESOURCE FOR UPLINK DRS, METHOD AND APPARATUS FOR TRANSMITTING INDICATOR INDICATING TYPE OF SUBFRAME/SLOT, AND METHOD AND APPARATUS FOR TRANSMITTING NUMBER OF DOWNLINK SYMBOLS

(71) Applicant: ELECTRONICS AND TELECOMMUNICATIONS RESEARCH INSTITUTE, Daejeon (KR)

(72) Inventors: Cheulsoon KIM, Daejeon (KR); Ji Hyung KIM, Daejeon (KR); Sung-Hyun MOON, Daejeon (KR); Juho PARK, Daejeon (KR)

(21) Appl. No.: 16/300,204

(22) PCT Filed: May 10, 2017
(86) PCT No.: PCT/KR2017/004842

§ 371 Date: Nov. 9, 2018

(30) Foreign Application Priority Data
May 13, 2016 (KR) 10-2016-0059067
Aug. 9, 2016 (KR) 10-2016-0101401
Sep. 30, 2016 (KR) 10-2016-0126986
Dec. 20, 2016 (KR) 10-2016-0174968
Apr. 24, 2017 (KR) 10-2017-0052423
May 8, 2017 (KR) 10-2017-0057610
Nov. 4, 2017 (KR) 10-2016-0147019

(51) Int. Cl. H04W 48/16; H04L 5/00; H04W 72/04; H04W 76/27; H04W 56/00; H04J 11/00; H04L 1/00; H04B 17/318

(52) U.S. Cl. CPC H04W 48/16; H04L 5/0051; H04W 72/0446; H04B 17/318; H04W 56/001; H04J 11/0069; H04L 1/0026; H04W 76/27

(57) ABSTRACT

A transmission method of a base station is provided. The base station configures a first resource for a physical downlink control channel (PDCCH). The base station includes configuration information of the first resource in a first physical broadcast channel (PBCH). In addition, the base station transmits the first PBCH.

### BACKGROUND

### 1. Technical Field

The present invention relates to a method and an apparatus of transmitting configuration information of a resource for a control channel.

Further, the present invention relates to a method and an apparatus of transmitting configuration information of a resource for an uplink discovery reference signal (DRS).

Further, the present invention relates to a method and an apparatus of transmitting an indicator indicating a subframe/slot type.

Further, the present invention relates to a method and an apparatus of transmitting the number of downlink symbols.

### 2. Description of Related Art

A wireless communication system supports frame structures depending on standards. For example, a 3^{rd} generation partnership project (3GPP) long term evolution (LTE) system supports three types of frame structures. The three types of frame structures include a type 1 frame structure that may be used for frequency division duplexing (FDD), a type 2 frame structure that may be used for time division duplexing (TDD), and a type 3 frame structure for transmission of an unlicensed frequency band.

In the wireless communication system such as the LTE system, a transmission time interval (TTI) means a basic time unit in which an encoded data packet is transmitted through a physical layer signal.

The TTI of the LTE system consists of one subframe. That is, a time-axis length of a physical resource block (PRB) pair, which is a minimum unit of resource assignment, is 1 ms. In order to support transmission of 1 ms TTI unit, most of physical signals and channels are defined in a subframe unit. For example, a cell-specific reference signal (CRS) is fixedly transmitted in each subframe, a physical downlink control channel (PDCCH), a physical downlink shared channel (PDSCH), a physical uplink control channel (PUCCH), and a physical uplink shared channel (PUSCH) may be transmitted per subframe. On the other hand, a primary synchronization signal (PSS) and a secondary synchronization signal (SSS) exist per fifth subframe, and a physical broadcast channel (PBCH) exists per tenth subframe.

Meanwhile, a study on the next generation communication system has been conducted. A transmission/reception method for the next generation communication system is required.

### SUMMARY

The present invention has been made in an effort to provide a method and an apparatus of transmitting configuration information of a control channel resource.

Further, the present invention has been made in an effort to provide a method and an apparatus of transmitting configuration information of an uplink (UL) discovery reference signal (DRS) resource.

Further, the present invention has been made in an effort to provide a method and an apparatus of transmitting an indicator indicating a subframe/slot type.

Further, the present invention has been made in an effort to provide a method and an apparatus of transmitting the number of downlink (DL) symbols.

An exemplary embodiment of the present invention provides a transmission method of a base station. The transmission method of a base station may include: configuring a first resource for a physical downlink control channel (PDCCH); including configuration information of the first resource in a first physical broadcast channel (PBCH); and transmitting the first PBCH.

The configuration information of the first resource may include an index of a resource block (RB) in which the first resource starts and a bandwidth occupied by the PDCCH.

The transmission method of a base station may further include: configuring a second resource for an uplink (UL) discovery reference signal (DRS) transmitted by a terminal; and including configuration information of the second resource in the first PBCH.

The configuring of the second resource may include configuring the second resource by the same number as the number of virtual sectors used by the base station.

The including of the configuration information of the second resource in the first PBCH may include: generating one first PBCH having a bit width corresponding to the number of virtual sectors used by the base station when the first PBCH is cell-specifically transmitted; and generating a plurality of first PBCHs for the virtual sectors when the first PBCH is virtual sector-specifically transmitted.

The transmitting of the first PBCH may include: transmitting a first synchronization signal (SS) burst including the first PBCH, a first primary synchronization signal (PSS), and a first secondary synchronization signal (SSS); and transmitting a second SS burst including a second PBCH having the same redundancy version (RV) as that of the first PBCH, a second PSS, and a second SSS.

The transmitting of the first PBCH may include: transmitting a first SS burst including the first PBCH, a first PSS, and a first SSS; and transmitting a second SS burst including a second PBCH having an RV different from that of the first PBCH, a second PSS, and a second SSS.

A scrambling resource for the first PBCH may be different from a scrambling resource for the second PBCH.

A cyclic redundancy check (CRC) mask for the first PBCH may be different from a CRC mask for the second PBCH.

Another exemplary embodiment of the present invention provides a transmission method of a base station. The transmission method of a base station may include: generating a first indicator indicating a type of a slot; including the first indicator in a physical downlink control channel (PDCCH); and transmitting the PDCCH to a terminal through a fixed downlink (DL) resource.

The first indicator may indicate whether the slot is a DL slot, a DL-centric slot, an uplink (UL) slot, or a UL-centric slot,

When the slot is the DL slot, a UL region may not exist in the slot.

When the slot is the UL slot, a DL region may not exist in the slot,

When the slot is the DL-centric slot, a DL region of the slot may be greater than a UL region of the slot.

When the slot is the UL-centric slot, a UL region of the slot may be greater than a DL region of the slot.

The transmitting of the PDCCH may include transmitting the first indicator using one or more first resource element groups (REGs) corresponding to identification information of the base station among REGs belonging to the fixed DL resource.

The transmission method of a base station may further include mapping PDCCH candidates different from the PDCCH to REGs other than the one or more first REGs among the REGs.

The transmitting of the first indicator using the one or more first REGs may include locating the one or more first REGs in a forefront time domain symbol of time domain symbols belonging to the slot.

The transmitting of the first indicator using the one or more first REGs may include mapping the one or more first REGs to a plurality of frequencies.

Yet another exemplary embodiment of the present invention provides a transmission method of a base station. The transmission method of a base station may include: determining the number of time domain symbols for a DL among time domain symbols belonging to a slot; determining a type of the slot; and transmitting a first channel including the determined number and the determined type through a common search space for a control channel.

The first channel can also be decoded by a terminal that is not connected to the base station by radio resource control (RRC).

The transmitting of the first channel may include locating one or more first REGs for transmitting a first indicator indicating the determined type among REGs belonging to a resource for the control channel in a forefront time domain symbol of time domain symbols for the DL.

The transmitting of the first channel may include mapping one or more first REGs for transmitting a first indicator indicating the determined type among REGs belonging to a resource for the control channel to a plurality of frequencies.

The time domain symbols for the DL may be used for radio resource management (RRM) measurement or channel state information (CSI) measurement.

### Advantageous Effects

According to an exemplary embodiment of the present invention, a method and an apparatus of transmitting configuration information of a control channel resource can be provided.

In addition, according to an exemplary embodiment of the present invention, a method and an apparatus of transmitting configuration information of an uplink (UL) discovery reference signal (DRS) resource can be provided.

Further, according to an exemplary embodiment of the present invention, a method and an apparatus of transmitting an indicator indicating a subframe/slot type can be provided.

Further, according to an exemplary embodiment of the present invention, a method and an apparatus of transmitting the number of downlink (DL) symbols can be provided.

Further, according to an exemplary embodiment of the present invention, a method and an apparatus of transmitting and receiving system information can be provided.

Further, according to an exemplary embodiment of the present invention, a radio resource management (RRM) measurement method and apparatus can be provided.

### BRIEF DESCRIPTION OF THE DRAWINGS

FIG. 1 is a view showing subframe/slot types that may be used for RRM measurement in the case of 3GPP NR TDD, according to an exemplary embodiment of the present invention.

FIG. 2 is a view showing a case in which 3GPP NR TDD consists of special subframes/slots to which both of a DL region and a UL region are assigned, according to an exemplary embodiment of the present invention.

FIG. 3 is a view showing a case in which subframes/slots used for RRM measurement are terminal-specifically (for example, UE-specifically) configured, according to an exemplary embodiment of the present invention.

FIG. 4 is a view showing a scenario for RRM measurement performed by a terminal according to an exemplary embodiment of the present invention.

FIG. 5 is a view showing RE mapping of DL NR-DRS resources according to an exemplary embodiment of the present invention.

FIG. 6 is a view showing a resource possessed by a 3GPP NR reference system in one subframe/slot.

FIG. 7 is a view showing method RSSI0-1 according to an exemplary embodiment of the present invention.

FIG. 8 is a view showing method RSSI0-1-1 according to an exemplary embodiment of the present invention.

FIG. 9 is a view showing method RSSI0-1-2 according to an exemplary embodiment of the present invention.

FIG. 10 is a view showing method RSSI0-2 according to an exemplary embodiment of the present invention.

FIG. 11 is a view showing method RSSI0-2-1 according to an exemplary embodiment of the present invention.

FIG. 12 is a view showing method RSSI0-2-2 for method RSSI0-2 according to an exemplary embodiment of the present invention.

FIG. 13 is a view showing method RSSI0-2-3 according to an exemplary embodiment of the present invention.

FIG. 14 is a view showing transmission of a NR-SIB according to an exemplary embodiment of the present invention.

FIG. 15 is a view showing virtual sectors of a base station according to an exemplary embodiment of the present invention.

FIG. 16a and FIG. 16b are views showing procedures in which a base station transmits an NR-SIB to a terminal according to an exemplary embodiment of the present invention.

FIG. 17 is a view showing a computing apparatus according to an exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the present specification, an overlapped description for the same components will be omitted.

Further, in the present specification, it is to be understood that when one component is referred to as being ‘connected to’ or ‘coupled to’ another component, it may be connected or coupled directly to another component or be connected or coupled to another component with the other component interposed therebetween. On the other hand, in the present specification, it is to be understood that when one component is referred to as being ‘directly connected to’ or ‘directly coupled to’ another component, it may be connected or coupled to another component without the other component interposed therebetween.

In addition, terms used in the present specification are used only in order to describe specific exemplary embodiments rather than limiting the present invention.

Further, in the present specification, singular forms are intended to include plural forms unless the context clearly indicates otherwise.

Further, in the present specification, it will be understood that the terms ‘include’ or ‘have’, specify the presence of features, numerals, steps, operations, components, parts, or combinations thereof mentioned in the present specification, but do not preclude the presence or addition of one or more other features, numerals, steps, operations, components, parts, or combinations thereof.

Further, in the present specification, a term ‘and/or’ includes a combination of a plurality of stated items or any one of the plurality of stated items. In the present specification, ‘A or B’ may include ‘A’, ‘B’, or ‘both of A and B’.

In addition, in the present specification, a terminal may indicate a mobile terminal, a mobile station, an advanced mobile station, a high reliability mobile station, a subscriber station, a portable subscriber station, an access terminal, a user equipment (UE), a machine type communication device (MTC), and the like, and may include all or some of the functions of the mobile terminal, the mobile station, the advanced mobile station, the high reliability mobile station, the subscriber station, the portable subscriber station, the access terminal, the UE, the MTC, and the like.

Further, in the present specification, a base station (BS) may indicate an advanced base station, a high reliability base station (HR-BS), a nodeB (NB), an evolved node B (eNB), a new radio (NR) nodeB (gNB), an access point, a radio access station, a base transceiver station, a mobile multihop relay (MMR)-BS, a relay station serving as a base station, a high reliability relay station serving as a base station, a repeater, a macro base station, a small base station, a femto base station, a home node B (HNB), a home eNB (HeNB), a pico BS, a micro BS, and the like, and may include all or some of the functions of the advanced base station, the HR-BS, the nodeB, the eNB, the gNB, the access point, the radio access station, the base transceiver station, the MMR-BS, the relay station, the high reliability relay station, the repeater, the macro base station, the small base station, the femto base station, the HNB, the HeNB, the pico BS, the micro BS, and the like.

Hereinafter, a method of transmitting and receiving system information in a mobile communication system will be described. In addition, a method for initial cell search in a new radio (NR) system will be described. Further, a method of measuring radio resource management (RRM) will be described. Further, a method of including an NR-physical downlink control channel (PDCCH) resource in an NR-physical broadcast channel (PBCH) will be described. Further, a method of including an uplink (UL) NR-discovery reference signal (DRS) resource in an NR-PBCH will be described. Further, a method of transmitting a redundancy version (RV) of an NR-PBCH on the basis of a specific combination will be described. Further, a method of indicating a subframe/slot type will be described. In the present specification, a subframe/slot means a subframe or a slot. In addition, in the present specification, the slot may mean a slot or a subframe. Further, a method of designing a physical subframe/slot type indicator channel (PSTICH) will be described. Further, a method of measuring a received signal strength indicator (RSSI) will be described. Further, a region of an RSSI measurement resource will be described. In the present specification, the NR-PDCCH may also be represented by a PDCCH, the NR-DRS may also be represented by a DSR, the NR-PBCH may also be represented by a PBCH, and the NR-PHICH may also be represented by a PHICH.

In a wireless communication system, cells periodically transmit reference signals (RSs), and a terminal receives the RSs. The terminal detects existence of the cells from the received RSs, and decides quality of wireless links from the cells to the terminal. Several methods may be applied to the quality of the wireless links depending on the purpose of applications. Terminal measurement defined in the technical specification 36.213 includes channel state information (CSI) measurement. Terminal measurement defined in the TS 36.214 includes a reference signal received power (RSRP), a reference signal received quality (RSRQ), a received signal strength indicator (RSSI), and a signal to interference plus noise ratio (RS-SINR).

The CSI measurement is performed by a terminal (for example, an RRC_CONNECTED UE) radio resource control (RRC)-connected to a base station. In the case in which a physical downlink shared channel (PDSCH) is transmitted in a CSI reference resource, a CSI report is generated so that a block error rate (BLER) corresponds to 10%.

RSs corresponding to transmission modes (TMs) configured by a serving cell (or a serving cell base station) are different from each other. For example, in the case of TM 5, an RS is a cell-specific reference signal (CRS), and in the case of TM 10, an RS is a CSI-RS. Therefore, a precoding matrix indicator (PMI), a rank indicator (RI), a channel quality indicator (CQI), or a CSI-RS resource indicator (CRI) is deduced. In the present specification, a cell may mean a base station providing or serving a cell.

The RSRP measurement is performed by the terminal (for example, an RRC_CONNECTED UE) that is RRC-connected to the base station and a terminal (for example, an RRC_IDLE UE) that is not RRC-connected to the base station. To this end, CRS antenna port 0 may be used or CRS antenna port 0 and CRS antenna port 1 may be used. Since the terminal already knows a sequence constituting the CRS and already knows a time domain boundary between symbols including the CRS, the RSRP is measured through an appropriate receiving algorithm in an RE including the CRS. In the present specification, a time domain symbol may be an orthogonal frequency division multiplexing (OFDM) symbol, a single carrier (SC)-frequency division multiple access (FDMA) symbol, or the like. However, this is only an example, and the present invention may also be applied to the case in which time domain symbol is a symbol different from the OFDM symbol or the SC-FDMA symbol. In the present specification, the time domain symbol may be represented by a symbol. The number of subcarriers utilized by the terminal depends on a measured bandwidth (for example, AllowedMeasBandwidth) allowed by the serving cell. The terminal utilizes only a subframe/slot allowed by a measured subframe pattern (for example, MeasSubframePattern) configured by the serving cell for the purpose of the RSRP measurement. The terminal utilizes only a subframe/slot belonging to a discovery reference signal measurement timing configuration (DMTC) for the purpose of the RSRP measurement. A unit of the RSRP is dBm, and is converted into and represented by a natural number defined in the TS.

The RSRQ measurement is performed by the terminal (for example, an RRC_CONNECTED UE) that is RRC-connected to the base station and the terminal (for example, an RRC_IDLE UE) that is not RRC-connected to the base station. The RSRQ is defined as a ratio between the RSRP and the RSSI. The RSSI measurement is performed in an OFDM symbol including the CRS antenna port 0, or all the OFDM symbols are utilized for the RSSI measurement in the case in a separate configuration by the serving cell exists. Only a subcarrier belonging to a physical resource block (PRB) utilized for the RSRP measurement is utilized for the RSSI measurement. A subframe/slot utilized by the terminal for the RSSI measurement corresponds to a subframe/slot utilized for the RSRP measurement. A unit of the RSRQ is dB, and is converted into and represented by a natural number defined in the TS.

In the case in which the terminal separately measures the RSSI, the terminal (for example, RRC_CONNECTED UE) RRC-connected to the base station measures the RSSI, and the RSSI is measured in only a subframe/slot configured by an RSSI measurement timing configuration (RMTC). The number of OFDM symbols utilized for the RSSI measurement may be configured by the RMTC. As an RSSI measurement timing, a downlink (DL) timing of the serving cell is used. A unit of the RSSI is dBm, and is converted into and represented by a natural number defined in the TS.

The RS-SINR measurement is performed by the terminal (for example, RRC_CONNECTED UE) RRC-connected to the base station, and is performed in an RE including CRS antenna port 0. The RS-SINR measurement is performed in a subframe/slot allowed by the serving cell. A unit of the RS-SINR is dB, and is converted into and represented by a natural number defined in the TS.

The CSI-RSRP measurement is performed by the terminal (for example, RRC_CONNECTED UE) RRC-connected to the base station, and is performed in an RE including CSI-RS antenna port 15. The terminal measures the CSI-RSRP in a subframe/slot belonging to subframes/slots configured by the DMTC. A subcarrier belonging to a bandwidth allowed by the serving cell is utilized for measuring the CSI-RSRP. A unit of the CSI-RSRP is dBm, and is converted into and represented by a natural number defined in the TS.

The serving cell may utilize the measurement of the terminal described above for several purposes. Link adaptation of the serving cell may perform DL scheduling depending on a CQI of the terminal (for example, RRC_CONNECTED UE) RRC-connected to the base station. Depending on a TM configured with respect to the terminal, a single user (SU)-multiple input multiple output (MIMO) operation or a multiple user (MU)-MIMO operation may be performed, and an open loop MIMO operation may be performed. DL load balancing of the serving cell re-configures RRC connection with respect to the terminal so that cell reselection is performed depending on an RSRP or an RSRQ of the terminal (for example, RRC_CONNECTED UE) RRC-connected to the base station. Handover of the serving cell uses the RSRP or the RSRQ in order to support mobility of the terminal (for example, RRC_CONNECTED UE) RRC-connected to the base station.

In the case of a frequency at which the serving cell is operated, the terminal may perform radio resource management (RRM) measurement in only a DL subframe/slot. However, in the case of inter-frequency RRM measurement or in the case in which neighbor cells are considered in long term evolution (LTE) time division duplexing (TDD), the terminal needs to decide whether or not a specific subframe/slot is the DL subframe/slot. To this end, the serving cell configures a TDD uplink (UL)-DL subframe/slot configuration and a multimedia broadcast multicast service over single frequency network (MBSFN) subframe/slot configuration with respect to the terminal together with a cell identifier list (cell ID list) through a measurement object configuration. Therefore, the terminal extracts a valid DL subframe/slot, and uses the valid DL subframe/slot for the RRM measurement.

In 3^{rd} generation partnership project (3GPP) new radio (NR), a study on technical requirements has been conducted in order to support a service scenario of an enhanced mobile broadband (eMBB), a service scenario of ultra-reliable low latency communication (URLLC), and a service scenario of massive machine type communications (mMTC).

The eMBB is to process massive traffics. The URLLC is to reduce a delay time of an end-to-end (E2E) layer 2 (L2) and reduce a layer 1 (L1) packet error rate. The mMTC is to serve traffics occasionally generated in a situation in which terminals are distributed at a geographically high density, through a small number of serving cell base stations. In the present invention, a case in which at least the eMBB and the URLLC are simultaneously supported and the mMTC is also supported if possible may be considered. Particularly, in order to support the URLLC, there are a method of defining a shorter transmission time interval (TTI) and a method of designing a channel encoder and a channel decoder to have shorter processing times or reducing a codeword size.

As the method of defining a shorter TTI, a method of reducing the number of time domain symbols constituting a TTI or a method of reducing a symbol length by widening a subcarrier spacing between subcarriers constituting a multicarrier symbol may be used.

A mixed numerology in which a plurality of subcarrier spacings are configured and operated is one of the features for distinguishing 3GPP NR and 3GPP LTE from each other.

In the case in which an operator having an unpaired spectrum deploys a 3GPP NR system, the system may be operated in TDD. In order to divide one system carrier into a DL subband and a UL subband to operate the system like frequency division duplexing (FDD), quite a few guard bands are required. In addition, when only small guard bands are assigned, in-band emission is large, such that full duplex processing needs to be considered. However, a situation in which strength of interference is much larger than that of a signal due to UL-DL mismatch between cells and UL-DL mismatch between terminals often occurs. However, since an analog to digital converter (ADC) resolution is finite, when interference having large strength is received, an ADC is operated depending on the large strength, such that a problem that the ADC may not detect relatively weak signals may occur. Therefore, it is difficult that the full duplex processing is always used.

Meanwhile, the 3GPP NR considers utilization of both of a high frequency of 6 GHz or more and a low frequency less than 6 GHz. Since a high frequency band of 6 GHz or more has a wide bandwidth, the 3GPP NR may assign a sufficient guard band even in one system carrier, and may operate a system like the FDD. However, in the case in which the 3GPP NR system is deployed in the high frequency region of 6 GHz or more, propagation path loss of a wireless channel is large, such that MIMO processing needs to be necessarily considered. Since the MIMO is based on a phased array, an amount of MIMO gain is significantly changed depending on channel estimation accuracy. When the FDD is used, uplink channel feedback for a large number of DL antenna ports requires an uplink signal overhead. On the other hand, in the case in which the system is operated in the TDD, when channel reciprocity is used and a transmitter unit (T×U) and a receiver unit (R×U) are appropriately calibrated, a DL channel response may be estimated through UL signals. When the TDD is used, the uplink signal overhead may be avoided. As another representation, when the TDD is used, a larger number of antenna ports may be defined.

When a scenario supporting both of the eMBB and URLLC utilizing the TDD is considered, low delay performance of the URLLC needs to be improved. In the case of 3GPP LTE TDD, the serving cell base station defines UL-DL subframe/slot patterns for the terminal through an RRC configuration. In the case of a DL traffic, when the serving cell base station transmits a scheduling assignment and DL data to the terminal in the DL subframe/slot, the terminal transmits a UL hybrid automatic repeat and request (HARQ) in the UL subframe/slot. Therefore, an L1 delay of the DL traffic depends on a frequency at which the DL subframe/slot and the UL subframe/slot appear. In the case of a UL traffic, when the serving cell base station transmits a scheduling grant to the terminal in the DL subframe/slot, the terminal transmits UL data in the UL subframe/slot, and the serving cell base station transmits a DL HARQ in the DL subframe/slot. Therefore, an L1 delay of the UL traffic depends on a frequency at which the DL subframe/slot and the UL subframe/slot appear.

On the other hand, in the case of a scenario supporting the URLLC utilizing the FDD, the DL subframe/slot and the UL subframe/slot always exist, and an L1 delay of the FDD is thus always equal to or smaller than that of the TDD.

In order to complement such a disadvantage, a method of converting a subframe/slot pattern in each subframe/slot may be used. The terminal receiving the scheduling assignment from the serving cell base station considers the corresponding subframe/slot as the DL subframe/slot. The terminal receiving the scheduling grant from the serving cell base station considers the corresponding subframe/slot as the UL subframe/slot. Terminals belonging to other cases neither assume that the corresponding subframe/slot is the DL subframe/slot, nor assume that the corresponding subframe/slot is the UL subframe/slot. In the case in which such a method is applied to the 3GPP NR, the serving cell base station needs to always assign some of radio resources as fixed DL resources in order for terminals in an idle state to perform the RRM measurement. The serving cell base station may define these fixed DL resources in a specific subframe/slot. The fixed DL resources may include information such as a discovery reference signal (DSR), a physical downlink control channel (PDCCH), a system information block (SIB), and the like. In the 3GPP NR, such a method is called dynamic TDD. When the 3GPP NR TDD is operated as the dynamic TDD, the serving cell base station may assign any UL resources and any DL resources as needed, such that an L1 delay of the URLLC scenario may be reduced. The dynamic TDD is one of the features for distinguishing the 3GPP NR and the 3GPP LTE from each other.

In the case of 3GPP LTE TDD, the terminal may predict the DL resources in the DL subframe/slot or a special subframe/slot. For example, since the DL resources mean all the subcarriers of DL symbols allowed by a subframe/slot type, a 3GPP LTE terminal may measure the RSSI using all the DL symbols, and may measure the RSRP in a subcarrier including the RS. Also in the case of inter-frequency measurement, the 3GPP LTE terminal may easily determine a subframe/slot type of a specific subframe/slot. For example, in the case in which the terminal detects a primary synchronization signal (PSS), the terminal may assume that the corresponding subframe/slot is the special subframe/slot or the DL subframe/slot. In the case in which the terminal detects a secondary synchronization signal (SSS), the terminal may assume that the corresponding subframe/slot is the DL subframe/slot. In the case in which UL-DL subframe configurations are configured with respect to the 3GPP LTE terminal, when the 3GPP LTE terminal knows a subframe/slot index of the corresponding subframe/slot, the 3GPP LTE terminal may know a type of subframe/slot that will appear later in advance.

On the other hand, in the case in which the 3GPP NR TDD is operated as the dynamic TDD, the fixed DL resources are determined in the TS regardless of the subframe/slot type. This is to allow an initial access even though a 3GPP NR terminal is in an idle state and the corresponding cell does not have separate previous information. The fixed DL resources include at least NR-PDCCH and DL NR-DRS. The fixed DL resources may have one numerology.

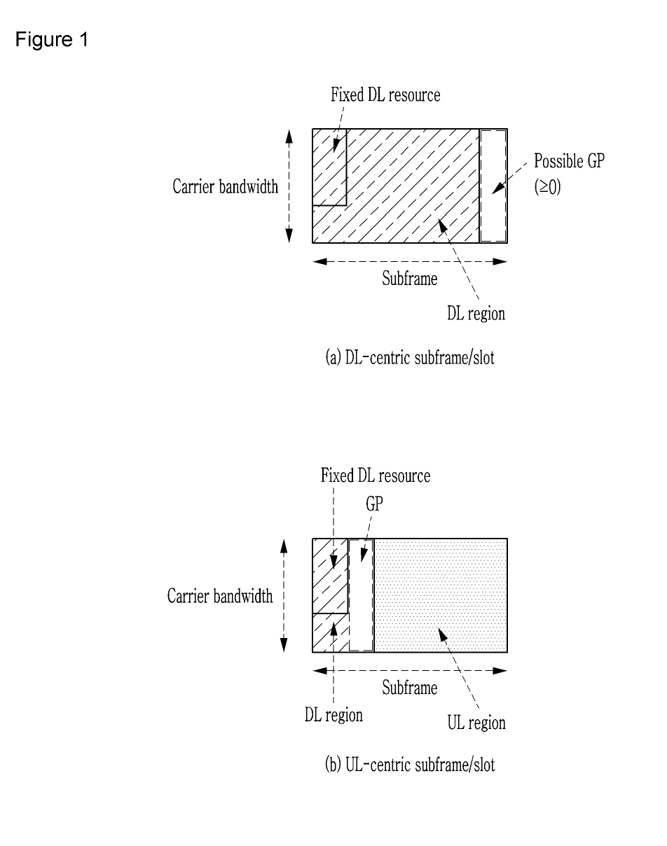

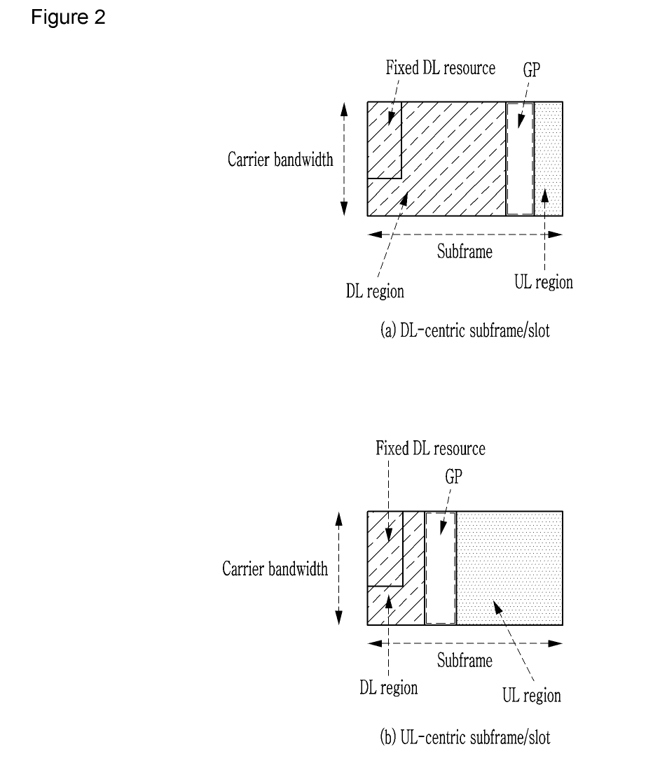

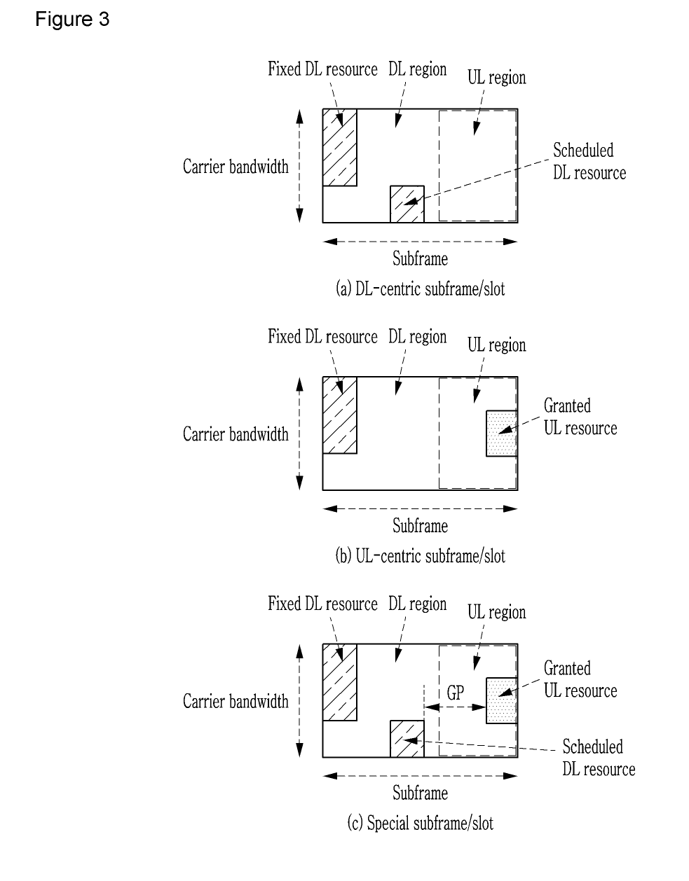

A subframe/slot type that may be used in a 3GPP NR TDD system may include at least cases shown in FIG. 1, FIG. 2, and FIG. 3 (reference system).

FIG. 1 is a view showing subframe/slot types that may be used for radio resource management (RRM) measurement in the case of 3^{rd} generation partnership project new radio time division duplexing (3GPP NR TDD), according to an exemplary embodiment of the present invention. In FIG. 1, a horizontal axis indicates a subframe/slot, and a vertical axis indicates a carrier bandwidth.

In detail, a DL-centric subframe/slot is shown in (a) of FIG. 1. The fixed DL resource includes a first symbol of a plurality of symbols belonging to a subframe/slot, and is transmitted at a fast point in time (for example, at the front of the slot). A symbol including the fixed DL resource is assumed as a DL region in all the subcarriers. Then, all of the other symbols are used as the DL region. This corresponds to GP (guard period)=0. If necessary (for example, GP≥1), a GP is configured through an RRC or may be defined in the TS. In this case, a symbol corresponding to the GP is not assumed as the DL region. In the DL region, DL data including several numerologies may be configured.

A UL-centric subframe/slot is shown in (b) of FIG. 1. The fixed DL resource includes a first symbol of a plurality of symbols belonging to a subframe/slot, and is transmitted at a fast point in time (for example, at the front of the slot). A symbol including the fixed DL resource is assumed as a DL region in all the subcarriers. A symbol located behind the fixed DL resource corresponds to the GP, and the serving cell base station needs to configure an appropriate number of symbols for the GP in consideration of a processing delay of the terminal and a timing advance command. The GP neither belongs to a DL region, nor belongs to an UL region, in all the subcarriers. A symbol (symbols) located after the GP corresponds to the UL region, and UL data are assigned to the corresponding symbol (symbols).

FIG. 2 is a view showing a case in which 3GPP NR TDD consists of special subframes/slots to which both of a downlink (DL) region and an uplink (UL) region are assigned, according to an exemplary embodiment of the present invention. Subframe/slots used for the RRM measurement are shown in FIG. 2. In FIG. 2, a horizontal axis indicates a subframe/slot, and a vertical axis indicates a carrier bandwidth.

A DL region is assigned before a symbol assigned as a GP in an intermediate region of the subframe/slot, and a UL region is assigned after the symbol assigned as the GP. The DL region includes at least a fixed DL resource. The UL region includes at least one symbol per subframe/slot.

In detail, a DL-centric special subframe/slot is shown in (a) of FIG. 2. The DL region occupies most of the subframe/slot.

A UL-centric special subframe/slot is shown in (b) of FIG. 2. The UL region rather than the DL region including the fixed DL resource occupies most of the subframe/slot.

The serving cell base station may differently utilize such a DL-centric subframe/slot or UL-centric subframe/slot per subframe/slot.

FIG. 3 is a view showing a case in which subframes/slots used for RRM measurement are terminal-specifically (for example, user equipment (UE)-specifically) configured, according to an exemplary embodiment of the present invention. In FIG. 3, a horizontal axis indicates a subframe/slot, and a vertical axis indicates a carrier bandwidth.

A DL-centric subframe/slot is shown in (a) of FIG. 3, a UL-centric subframe/slot is shown in (b) of FIG. 3, and a special subframe/slot is shown in (c) of FIG. 3.

In detail, as shown in (a) of FIG. 3, the serving cell base station may schedule DL data (or a DL resource) to the terminal through decision of a scheduler even though a cell-specific subframe/slot type is fixed to a special subframe/slot. As shown in (b) of FIG. 3, the serving cell base station may grant UL data (or a UL resource) to the terminal. As shown in (c) of FIG. 3, the serving cell base station may assign (or schedule or grant) DL data (or a DL resource) and UL data (or a UL resource) in the same subframe/slot.

In the case of FIG. 3, a separate GP is not defined to be cell-specific, and a DL region and a UL region are defined.

The 3GPP NR cell may implicitly assign a terminal-specific (for example, UE-specific) GP to reduce a GP overhead. Since the cell-specific GP does not exist, the scheduler needs to perform scheduling by adjusting DL-UL interference. For example, in the case in which the serving cell assigns different subframe/slot types to different two terminals UE1 and UE2 and the two terminals UE1 and UE2 have a similar geographic location in a boundary zone (for example, a cell edge) of a coverage, a propagation delay is large in the terminal UE1 to which the DL-centric subframe/slot is assigned, and a timing advance is large in the terminal UE2 to which the UL-centric subframe/slot is assigned. In this case, interference is generated in a specific symbol, the terminal UE1 acts as a victim, and the terminal UE2 acts as an aggressor. Therefore, the serving cell base station appropriately adjusts the number of symbols occupied by the DL data and the number of symbols occupied by the UL data, and needs to perform adjustment so as to prevent the interference scenario described above.

Meanwhile, since a mobile communication system is mainly deployed in a low band (for example, 2 GHz) in which propagation characteristics are good, even though the base station does not perform separate beamforming, the terminal relatively easily receives information. For example, in the case of the 3GPP LTE, a base station antenna is installed at a relatively high location (for example, a rooftop of a building). Since the terminals are in a relative low location, the base station antenna is steered at an angle slightly lower than a horizontal angle. This is mechanical tilting. In order for the base station to perform electrical tilting, the base station receives channel information fed back from the terminal, and performs precoding in a baseband. This may be interpreted depending on the electrical tilting.

Even though separate baseband precoding is not performed, the base station periodically transmits synchronization signals (for example, PSSs and SSSs) and cell common signals (for example, CRSs) using the mechanical tilting, and periodically transmits a physical broadcast channel (PBCH). The terminal receives the PSSs, the CSSs, the CRSs, and the PBCH to obtain synchronization, and decodes a master information block (MIB) included in the PBCH. This information may be used to search a PDCCH and receive an SIB.

On the other hand, when a mobile communication system operated in a high band (for example, 60 GHz) is considered, the base station may transmit information to the terminal through separate beamforming. Since diffraction characteristics and reflection characteristics of propagation are not good, propagation characteristics are not generally good. Therefore, the base station may use both of the mechanical tilting and the electrical tilting in order to transmit data to the terminal. In addition, the base station may efficiently transmit necessary system information transferred to the terminal using the beamforming. The base station may determine the beamforming through feedback information from the terminal. For example, according to Institute of Electrical and Electronics Engineers (IEEE) 802.11 ad, in a wireless communication system operated in a band of several tens of GHz, a beam sweeping procedure is performed in order for the terminal to communicate with the base station.

The beam sweeping procedure includes two steps. In a first step of the beam sweeping procedure, all the base station sectors form rough beams, respectively, to transmit predefined packets, and the terminal receives the predefined packets. The terminal selects one of several base station sectors, and feeds back an index of the selected base station sector to the base station.

In a second step of the beam sweeping procedure, the base station receives the feedback of the terminal, and then forms fine beams within the base station sector selected by the terminal to transmit predefined packets, and the terminal receives the predefined packets. The terminal feeds back a beam index of one of several fine beams to the base station. The base station may know a fine beam that may be used when it transmits data to the terminal.

Such a beam sweeping procedure has complexity directly proportional to the sum of the number of rough beams formed by the base station and the number of fine beams formed per sector. When the base station forms only the fine beams and transmits the fine beams to the terminal, a larger number of beams are transmitted. Therefore, this is inefficient.

In order to use the beam sweeping procedure including the two steps, an assumption that a reliability feedback link from the terminal to the base station exists is required. However, since system information for receiving resources assigned from the base station is required in order for the terminal to perform the feedback, it is difficult to apply the beam sweeping procedure described above to the mobile communication system. Since the base station or the terminal needs to perform repetition or perform transmission at a low code rate in order to reduce error probability, transmission resources need to be additionally assigned.

Therefore, in order for data (an NR-PDSCH) to be transmitted in an NR system operated at several tens of GHz, a beamformed control channel (for example, an NR-PDCCH) needs to be transmitted to the terminal. This is also applied to system information (for example, an NR-SIB). The terminal may know a location of a resource (for example, the NR-PDSCH) in which the NR-SIB exists, from a DL assignment received through the NR-PDCCH. Since the feedback of the terminal is necessarily required in order for the base station to determine a beamforming method, a separate physical channel for indicating the feedback is required. An NR-PBCH performs such a role. The base station periodically transmits the NR-PBCH using a resource defined in the specification. In the case in which the base station uses the beam sweeping, the base station may assume an NR synchronization signal and a predetermined relative resource location and continuously transmit the NR-PBCH. Per transmission, the base station may use different beams.

The terminal decodes the NR-PBCH in a radio resource defined in the specification. Hereinafter, properties of the NR-PBCH will be described. An NR-subframe may be represented by an NR-slot in some cases. The NR-subframe is a unit consisting of x (here, x=7 or 14) symbols. Therefore, lengths of the NR-subframes may be different from each other per numerology.

In the 3GPP LTE system, a LTE-PBCH periodically transmitted by the base station includes an LTE-MIB. Information transferred by the LTE-MIB corresponds to a system bandwidth, LTE-physical hybrid automatic repeat and request indicator channel (LTE-PHICH) assignment information, and a system frame number (SFN).

The system bandwidth may inform the terminal of a sequence length of an LTE-CRS, and inform the terminal of a range in which LTE-PDCCH resources are distributed.

The LTE-PHICH assignment information is required in order to detect a location of a control channel element (CCE). In the LTE-PDCCH resources, a resource element group (REG) that does not assign the CCE and an REG that assigns the CCE are distinguished from each other.

The SFN is information required in order to interpret a system information (SI) window and SIB scheduling information included in LTE-SIB type 1. A temporal location of an LTE-subframe/slot in which the SIB is received is defined by the TS, and the terminal obtains frame synchronization through the SFN to receive LTE-SIB type 1.

The LTE-PBCH includes an LTE-MIB, and is transmitted per radio frame (for example, 10 ms). Channel coding and a message size of the LTE-PBCH are defined in the TS.

LTE-SIB type 1 is transmitted per two radio frames (for example, 20 ms). A subframe in which LTE-SIB type 1 is transmitted is defined in the TS, but channel coding, a message size, and the like, of LTE-SIB type 1 are indicated by an LTE-PDCCH to which dynamic scheduling is applied.

System information other than LTE-SIB type 1 is limited to a type designated by a scheduling information list (for example, schedulingInfoList) included in LTE-SIB type 1, and is sequentially transmitted by the base station.

The terminal blind-decodes the LTE-PDCCH through an SI-radio network temporary identifier (RNTI) in a subframe (subframes) belonging to the number of window lengths (for example, si-WindowLength) on the basis of a specific subframe index depending on an equation defined in the TS to decode the LTE-SIB.

Only one LTE-SIB is included within a window (for example, si-Window), and the terminal may not know a subframe index in which the LTE-SIB is received in advance, and may know an LTE-SIB type through LTE-SIB type 1 in advance. Such a type is uniquely determined.

Information included in LTE-SIB type 1 is information on whether or not it is suitable for cell selection and information on time domain scheduling of another SIB. LTE-SIB type 2 includes information on a common channel and a shared channel. LTE-SIB type 3, type 4, type 5, type 6, type 7, and type 8 include parameters required for intra-frequency cell reselection, inter-frequency cell reselection, and inter-radio access technology (RAT) cell reselection).

The NR-PBCH does not necessarily require the information described above. In the case in which the NR-PDCCH is not distributed over the entire band, the base station does not need to inform the terminal of a system bandwidth. In addition, the NR applies an adaptive and non-synchronous HARQ-acknowledgement (ACK) to both of the DL and the UL, such that the base station may not transmit the NR-PHICH. Alternatively, even though the base station transmits the NR-PHICH, the NR may design the NR-PDCCH and the NR-PHICH not to use the REG as a common resource pool. In this case, the NR-PBCH does not include the PHICH information. In addition, when the base station does not periodically perform the SIB transmission, but performs the SIB transmission on-demand by a request of the terminal, the NR does not also require the SFN. Therefore, when a design of the NR-PDCCH is different from that of the LTE-PDCCH, the base station does not need to transmit the MIB, and the SFN and the PHICH information described above may be included in the NR-SIB transmitted to the terminal by the base station.

However, the base station needs to perform appropriate precoding in order to transmit the NR-PDCCH. In the case in which the base station receives separate information and may perform beamforming of terminals on the basis of the received information (for example, a non-standalone scenario), appropriate beamforming for the NR-PDCCH may be performed. However, in the case in which the NR is operated in a standalone form (for example, a standalone scenario), information for precoding that is to be applied to the NR-PDCCH may be obtained through UL feedback from the terminal.

This corresponds to a case in which a UL-based terminal search (for example, UE discovery) is performed. The terminal transmits a UL NR-DRS to the base station. Here, the UL NR-DRS means a signal of a physical layer that the terminal transmits regardless of a separate base station configuration. The terminal may transmit the UL NR-DRS even though it does not know a power control and a timing advance. This does not mean only an NR-physical random access channel (PRACH) preamble.

The base station (for example, the serving cell base station) receives the UL NR-DRS, and may know existence of one or more terminals. The base station forms reception beams through implementation, and may utilize the reception beams for precoding on the basis of channel reciprocity.

In the case in which the base station may not utilize the channel reciprocity, the terminal may perform Tx beam sweeping using a UL NR-DRS occasion in which the UL NR-DRS is transmitted several times. The number of resources of the UL NR-DRS transmitted by the terminal may be configured to be one or more. The terminal may transmit a precoded NR-DRS in each UL NR-DRS resource. In this case, a utilized precoding method may be separately indicated to the terminal by the base station. In the case in which a separate indication for the precoding method does not exist, the terminal may repeatedly transmit UL NR-DRSs to which the precoding is not applied or the same precoding is applied in the UL NR-DRS resources.

The UL NR-DRSs belonging to the UL NR-DRS resource (resources) do not necessarily have the same sequence identifiers (IDs) and the same resources (frequency and time resources). In the case in which the terminal transmits an UL NR-DRS that is not precoded over several uplink slots, the terminal may transmit one UL NR-DRS sequence over the several uplink slots using one long sequence. As another method, a length of one UL NR-DRS sequence may be equal to smaller than that of one uplink slot, and terminal may transmit several UL NR-DRS sequences over several uplink slots. In this case, the UL NR-DRS sequences do not necessarily have the same sequence identifiers (IDs) and the same resources (frequency and time resources).

The terminal needs to know UL resources for UL feedback. It is assumed that configuration information of an NR-sounding reference signal (NR-SRS) is the same as of the LTE SRS. The terminal needs to know a transmission power, a transmission bandwidth, and a timing advance of the NR-SRS.

It is assumed that an NR-PRACH preamble has a property equal to that of an LTE PRACH preamble. When the terminal knows a resource location of the NR-PRACH preamble, the terminal transmits the NR-PRACH preamble in the corresponding resource. The terminal determines an NR-PRACH preamble index through terminal identification information (for example, UE ID) or a function of the terminal identification information and a slot index among indices belonging to an NR-PRACH preamble index set defined in the TS, and transmits the determined NR-PRACH preamble index to the base station.

The base station receives the NR-PRACH preamble index, and may estimate at which virtual section the terminal is located or a radio channel using the NR-PRACH preamble index. The base station may utilize the information estimated as described above for the precoding on the basis of the channel reciprocity. Since an amount of configuration information required by the NR-PRACH preamble is less than that of configuration information required by the NR-SRS as described above, the NR-PRACH preamble may be utilized as the UL NR-DRS.

In the case in which the base station may not utilize the channel reciprocity, precoding of the UL NR-DRS is determined through a separate method. The base station may include UL NR-DRS precoding information of the terminal in the NR-PDCCH or a random access response, and transmit the NR-PDCCH or the random access response including the UL NR-DRS precoding information to the terminal.

In order to use the channel reciprocity assumed by the base station, it is advantageous that a radio resource in which the UL NR-DRS received from the terminal is located and a radio resource that is to be transmitted by the base station are the same as each other. In other words, a method in which the terminal transmits the UL NR-DRS using a DL frequency resource may be considered. In the case in which the NR consists of the TDD, such a method may be used. Also in the case in which the NR consists of the FDD, it may be allowed that the terminal uses the DL frequency resource in order to maximally use the channel reciprocity.

In order for the base station to transfer configuration information of the NR-PRACH preamble to the terminal, the terminal needs to search existence of the base station. This corresponds to a case of performing a DL-based cell search (or cell discovery). The base station transmits a DL NR-DRS. In order for the terminal to receive and utilize the DL NR-DRS even though it does not have any information in advance, the DL NR-DRS transmitted by the base station uses a radio resource defined in the specification. A sequence of the DL NR-DRSs is generated from an equation including at least indices of virtual sectors or identification information (for example, identification) of the virtual sectors.

In addition, precoding applied to one virtual sector by the serving base station is similarly applied to the NR-DRS, the NR-PBCH, and the like. In the present specification, the NR-DRS (or the PSS or the SSS) and the NR-PBCH will be referred to as SS bursts. Therefore, in the present specification, one virtual sector corresponds to one SS burst in a one-to-one scheme.

As an example of an NR DL-DRS resource, an NR-SSS (or an NR-SSS resource) may not only be utilized for downlink synchronization, but also be utilized as the NR DL-DRS resource, may be used for the RSRP measurement, or may be utilized for demodulation of the NR-PBCH.

A method of transmitting the DL NR-DRS by the base station will be described. In detail, a method (hereinafter, referred to as ‘method S1’) of transmitting the NR-DRS in one step and a method (hereinafter, referred to as ‘method S2’) of transmitting the NR-DRS in two steps will be described.

In method S1, the base station assigns the DL NR-DRS resources per virtual sector, and the terminal receives the DL NR-DRSs and estimates sequence information of the DL NR-DRSs. The terminal may know an index i of a virtual sector to which the terminal belongs from the DL NR-DRS sequence. The terminal may transfer the index i of the virtual sector to the base station using a reliable feedback link. Here, as a method of performing reliable feedback, the method of transmitting the UL NR-DRS by the terminal as described above may be considered. The terminal may select a radio resource used by the UL NR-DRS to implicitly transfer the index of the virtual sector to the base station. For example, when the base station configures several UL NR-DRS resources and the terminal selects an i-th UL NR-DRS resource of the UL NR-DRS resources and transmits the UL NR-DRS using the selected resource, the base station may estimate an index i of a virtual sector to which the terminal belongs. As described above, the base station may estimate the index of the virtual sector, and form sharp beams toward the terminal using the signal received from the terminal. In order for method S1 to be performed, the base station needs to perform preprocessing using the signal from the terminal.

For example, the following equations may be considered in order for the base station to form the sharp beams toward the terminal. For convenience of explanation, a signal model in which noise is not present is assumed. A radio channel from the base station to the terminal is represented by matrix H. Matrix H has a DL channel (which has the number of antennas possessed by the base station as a column and has the number of antennas possessed by the terminal as a row) as a complex number value. A precoding vector that the base station uses while forming a virtual sector (index i) may be represented by Pᵢ, and a length of Pᵢ corresponds to the number of antennas possessed by the base station.

In the case in which it is assumed that the number of DL NR-DRS antenna ports is 1, the base station allows an i-th virtual sector and an i-th DL NR-DRS resource to correspond to each other, and the same precoding vector Pᵢ is thus used. For convenience, a value of an i-th DL NR-DRS may be represented by 1. A signal received by the terminal is yᵢ=H(pᵢ1).

The terminal estimates an effective channel \tilde{h}ᵢ=HPᵢ using a separate linear matched filter vector qᵢ per resource of the DL NR-DRS. In this case, a matching process may be represented by qᵢ^{H}yᵢ, and qᵢ=α\tilde{h}ᵢ=αHpᵢ is obtained. Here, a magnitude (for example, 2-norm) of qᵢ is adjusted to 1 using a complex number α.

The terminal obtains an index i=max{i∥qᵢ^{H}yᵢ|,∀i} of which an absolute value of a result value obtained after the DL NR-DRS is received is largest among indices. The terminal precodes the UL NR-DRS and transmits the precoded UL NR-DRS to the base station, and qᵢ* is used by a precoding vector applied in the case in which the number of UL NR-DRS antenna port is 1.

Here, qᵢ* means a conjugate complex number of qᵢ.

In the case in which the terminal transmits the UL NR-DRS in a DL frequency, a radio channel from the terminal to the base station may be represented by H^{T} by the channel reciprocity. When the UL NR-DRS is represented by 1 for convenience, a signal Zᵢ that the base station receives in a radio resource assigned to correspond to the i-th virtual sector corresponds to zᵢ=H^{T}(qᵢ*1). The base station estimates an effective channel ĥᵢ=H^{T}qᵢ* using a separate linear matched filter vector Wᵢ per radio resource assigned to correspond to the i-th virtual sector. In this case, a matching process may be represented by wᵢ^{H}zᵢ, wᵢ=βĥᵢ=βH^{T}qᵢ*=βαH^{T}H*pᵢ* and is obtained. Here, a magnitude (for example, 2-norm) of Wᵢ is adjusted to 1 using a complex number β.

Then, the base station may transmit the system information (for example, the NR-SIB) to the terminal through a data channel (for example, an NR-PDSCH) using a precoding vector V for transmission to the terminal. Alternatively, the base station may apply the precoding vector V in the case of transmitting the control channel (for example, the NR-PDCCH).

In the case in which the base station applies v=wᵢ* as the precoding vector to the terminal, a received signal of the terminal is represented by y=Hv1=Hw′ᵢ*1, which corresponds to y=βαHH^{H}Hpᵢ. Here, 1 indicates an NR-demodulation (DM)-RS used by the base station for convenience.

The terminal may receive a signal using c=Hpᵢ that is already known. c^{H}y that the terminal obtains using a linear vector C may be represented by c^{H}y=αβc^{H}HH^{H}Hpᵢ=αβpᵢ^{H}H^{H}HH^{H}Hpᵢ=αβ∥H^{H}Hpᵢ∥². This value may be compared with ∥HPᵢ∥, which is strength received by the terminal in the DL NR-DRS, and may be compared with ∥H^{H}Hpᵢ∥, which is strength received by the terminal in the DL NR-DM-RS.

When H is represented by H=UDV^{H} through skinny singular value decomposition, ∥Hpᵢ∥²=pᵢ^{H}V^{H}|D|²Vpᵢ and ∥H^{H}Hpᵢ∥²=pᵢ^{H}V^{H}|D|⁴Vpᵢ. Here, D is a square matrix, and has singular values as elements (for example, positive real numbers). U indicates a left singular value matrix of H, and V indicates a right singular value matrix of H.

Therefore, an exponent for |D| becomes high, and a difference is thus present in a ratio (for example, a condition number) of singular values. Therefore, it may be interpreted that the base station forms fine beams in the NR-DM-RS. When the terminal uses an optimal linear matched vector, high reception strength may be obtained. On the basis of such a method, the base station may utilize method S1 in order to obtain the sharp beams.

In the case in which it is difficult for the base station to perform digital precoding, but the base station may perform analog beamforming, the base station may not form the sharp beams only by a method (for example, method S1) of transmitting the NR-DRS in one step in order to perform the precoding. In this case, a method (for example, method S2) of transmitting the NR-DRS in two steps may be used.

In a first step belonging to method S2, the base station assigns the DL NR-DRS resources per virtual sector, and the terminal estimates an index i of a virtual sector to which the terminal belongs using the DL NR-DRSs. This step is the same as that of method S1.

A second step belonging to method S2 is performed in the case in which feedback of the terminal exists. The base station precodes separate DL NR-DRSs one by one per sharp beam so as to form the sharp beams in the virtual sector (index i) selected by the terminal. The terminal receives the DL NR-DRSs represented through the respective sharp beams, and estimates sequence information of the DL NR-DRSs. The terminal estimates an index j of the sharp beam using the same method as the method of extracting the index of the virtual sector by the terminal in method S1. The terminal may implicitly transfer the index of the sharp beam to the base station using the same method as the method of providing the feedback to the base station by the terminal in method S1′. In the case in which the base station may perform analog beamforming and it is difficult for the base station to perform digital precoding, the base station may form sharp beams j that may be applied to the terminal using method S2.

However, in method S2, radio resources corresponding to the number of sharp beams are consumed, which is a large burden to the base station. When several beams are spatial-division-multiplexed (SDM), the several beams are transmitted in a state in which a power is uniformly divided, and a coverage of each beam is thus reduced. When several beams are frequency-division-multiplexed (FDM), a phenomenon that the several beams are transmitted in a state in which a power is divided similarly occurs. When several beams are time-division-multiplexed (TDM), areas of sharp beams may be secured, but the base station needs to command the terminal to measure the sharp beams for a long time, such that latency performance is low. Even though several beams are multiplexed through several multiplexing methods, separate radio resources are required in order for the base station to pre-configure these multiplexing methods with respect to the terminal.

A method of transmitting the NR-PBCH and the NR-PDCCH by the base station will be described. In detail, a method (hereinafter, referred to as ‘method T1’) of independently transmitting the NR-PBCHs and the NR-PDCCHs per virtual sector of the base station and a method (hereinafter, referred to as ‘method T2’) of transmitting the same NR-PBCHs and NR-PDCCHs per physical sector of the base station will be described.

In method T1, per virtual sector of the base station, resources of the NR-PBCHs may be different from each other, and resources of the NR-PDCCHs may be different from each other.

In the case in which the NR-PBCHs and the NR-PDCCHs are separately assigned per virtual sector, the base station may use the TDM, the FDM, or the SDM, and divide search spaces of the NR-PDCCHs to support different virtual sectors.

For example, the base station may configure NR-subframe/slot offsets of the NR-PBCHs and the NR-PDCCHs to be the same as each other per virtual sector. However, the base station may configure NR-subframe/slot offsets of the NR-PBCHs to be different from each other per virtual sector, and may configure NR-resource block (RB) indices of the NR-PDCCHs to be different from each other per virtual sector. Such an independent configuration may be utilized as a means for avoiding interference between the NR-PBCHs of the virtual sectors and interference between the NR-PDCCHs of the virtual sectors.

As another example, the serving base station may transfer scheduling information to terminals located in different virtual sectors in the same slot by applying different precodings to control channel elements (CCEs) belonging to terminal search spaces (for example, user-specific search spaces) of the NR-PDCCHs.

The terminal may receive the NR-DRSs and the NR-PBCHs from several virtual sectors, and may select a virtual sector having higher reception quality with respect to the NR-DRSs (or the NR-PBCHs and the NR-DRSs).

In method T1-1 for method T1, the terminal selects only one virtual sector. In method T1-2 for method T1, the terminal is allowed to select a plurality of virtual sectors.

When method T1-1 is used, a content indicated by the NR-PBCH is applied to one virtual sector. However, when method T1-2 is used, a content indicated by the NR-PBCH may be applied to each of several virtual sectors. For example, in the case in which the UL NR-DRS resources are configured through the NR-PBCH, when method T1-2 is used, the terminal may select several UL NR-DRS resources, and transmit each of the UL NR-DRSs using the selected UL NR-DRS resources.

In method T2, the NR-PBCH resources and the NR-PDCCH resources are configured to be the same as each other with respect to all the virtual sectors, the NR-PBCH resources are configured to be the same as each other with respect to all the virtual sectors, or the NR-PDCCH resources are configured to be the same as each other with respect to all the virtual sectors. As an example, in the case in which the NR-PBCH includes UL NR-DRS resource configurations corresponding to the respective virtual sectors, the same one NR-PBCH may include several UL NR-DRS resources. As another example, the NR-PBCH may include several NR-PDCCH resources corresponding to the respective virtual sectors. In method T2, many payloads of the NR-PBCH are required in order for one NR-PDCCH to include configuration information directly proportional to the number of virtual sectors.

A method of configuring the UL NR-DRS resources will be described. In detail, method R1 corresponds to a case in which locations of the UL NR-DRS resources are fixed by the specification. Method R2 corresponds to a case in which locations of the UL NR-DRS resources may be configured.

In method R1, since the locations of the UL NR-DRS resources are fixed by the specification, the terminal may receive the UL NR-DRS from the base station without separate signaling. Therefore, the base station does not configure the UL NR-DRS resources in any other physical channels as well as the NR-PBCH. However, since the base station may not use a union of the UL NR-DRS resources as radio resources, method R1 is inefficiency in the case in which the number of terminals is small. In addition, it needs to be allowed that the UL NR-DRS resources are configured in terms of supporting forward compatibility of the NR.

In method R2, the base station needs to assign separate radio resources in order to configure the locations of the UL NR-DRS resources. In order for the base station to form the sharp beams to transmit data to the terminal, the NR-PBCH may include the locations of the UL NR-DRS resources. For example, the base station may configure resources for the UL NR-DRSs, include configuration information of the UL NR-DRS resources in a broadcasting channel (for example, the NR-PBCH), and transmit the broadcasting channel. The number of UL NR-DRS resources possessed by the NR-PBCH is one or more, which is the same as the number of virtual sectors utilized by the base station. For example, the base station may configure the UL NR-DRS resources by the number that is the same as that of virtual sectors used by the base station. Since the base station may configure the UL NR-DRS resources by transmitting the NR-PBCH, the base station supports the forward compatibility.

The NR-PBCH may further include bits informing the terminal of whether or not the system information is transmitted, in addition to the configuration information of the UL NR-DRS resources. The system information may be transmitted using the NR-PDCCH, between subframes/slots including the NR-PBCH. For example, the base station may include a bit field indicating whether or not the system information is transmitted through the control channel (for example, the NR-PDCCH) in the broadcasting channel (for example, the NR-PBCH). In this case, a time interval corresponding to a periodicity of the NR-PBCH is a window for reception of the system information, and the terminal observes the corresponding bit field in the NR-PBCH. When the terminal detects the bit indicating that the base station transmits the system information, the terminal assumes that it receives a system information block before it receives the next NR-PBCH, and performs blind decoding on the NR-PDCCH. To this end, the terminal appropriately updates a discontinuous reception (DRx) timer. When the terminal detects the bit indicating that the base station does not transmit the system information, the terminal does not need to observe the NR-PDCCH. In the case in which method R2 and method T1-2 are used together, the NR-PBCH has a bit width corresponding to the number of virtual sectors, and may be cell-specifically transmitted. Alternatively, when the NR-PBCH is virtual sector-specifically transmitted, the transmission of the NR-PBCH is defined by the number of virtual sectors, and one NR-PBCH may include one bit. As an example, in the case in which the base station intends to cell-specifically transmit the NR-PBCH, the base station may generate one broadcasting channel having a bit width corresponding to the number of virtual sectors. As another example, in the case in which the base station intends to virtual sector-specifically transmit the NR-PBCH, the base station may generate a plurality of NR-PBCHs for a plurality of virtual sectors.

A method of configuring the NR-PDCCH resources will be described.

It may be assumed that the NR-PDCCH is transmitted in all the NR-subframes/slots by the base station. Alternatively, it may be assumed that the NR-PDCCH is transmitted in all the NR-subframes/slots after the base station receives the UL NR-DRS. Time resources occupied by the NR-PDCCH may be predefined in the specification, be configured through the NR-PBCH, be signaled through the NR-PDCCH, or be designated through an NR-physical control format indicator channel (NR-PCFICH) transmitted together with the NR-PDCCH.

The base station may perform appropriate precoding on the NR-PDCCH and then transmit the NR-PDCCH to the terminal. The terminal decodes the NR-PDCCH using the NR-DM-RS. Here, as a method of configuring frequency resources of the NR-PDCCH, there are method C1 and method C2. Method C1 corresponds to a case in which locations of the NR-PDCCH resources are fixed by the specification. Method C2 corresponds to a case in which locations of the NR-PDCCH resources may be configured. Method C1 and method C2 relate to methods of defining the NR-PDCCH, but information included in the NR-PBCH may be determined according to a detailed exemplary embodiment of method C2.

In method C1, since the locations of the frequency resources used by the NR-PDCCH are fixed by the specification, the terminal may receive the NR-PDCCH from the base station without separate signaling. Therefore, the base station does not configure the locations of the frequency resources used by the NR-PDCCH in any other physical channels as well as the NR-PBCH. However, the base station may assign the RBs belonging to a union of the NR-PDCCH resources to data transmission. In addition, it needs to be allowed that the NR-PDCCH resources are configured in terms of supporting forward compatibility of the NR.

For example, when the terminal transmits the UL NR-DRS, the base station may transmit the NR-PDCCH in frequency resources defined by the specification. The specification designates a minimum bandwidth to allow the base station to be operated even in the case in which the base station has a narrow system bandwidth. The base station scheduling-assigns the NR-PDSCH including the NR-SIB while transmitting the NR-PDCCH.

The terminals transmitting the UL NR-DRS receive the NR-PDCCH, and decode the NR-SIB. The base station may separately configure NR-PDCCH-eMBB resources or separately configure NR-PDCCH-URLLC resources while establishing NR-RRC connection in order to provide an eMBB service or a URLLC service to the terminal through the NR-PDSCH in addition to the NR-SIB. The terminal receiving such a configuration does not receive the NR-PDCCH any more, and may receive an NR-PDCCH-eMBB or an NR-PDCCH-URLLC. The base station transmitting such a configuration does not transmit the NR-PDCCH to the terminal any more.

In method C2, the base station needs to assign separate radio resources in order to configure locations of frequency resources used by the NR-PDCCH. In order for the base station to form the sharp beams to transmit data to the terminal, the NR-PBCH may include locations of the NR-PDCCH resources. For example, the base station may configure resources for the NR-PDCCH, and include configuration information of the NR-PDCCH resources in the NR-PBCH. The number of NR-PDCCH resources possessed by the NR-PBCH is one or more, and one NR-PDCCH resource corresponds to a virtual sector utilized by the base station. The locations of the NR-PDCCH resources include an RB index or an NR-PDCCH bandwidth. That is, the configuration information of the NR-PDCCH resources may include an index of an RB at which the NR-PDCCH resource starts and a bandwidth occupied by the NR-PDCCH. The terminal receives the frequency resources of the NR-PDCCH from RBs belonging to the bandwidth occupied by the NR-PDCCH on the basis of the RB index. Since the base station may configure the NR-PDCCH resources by transmitting the NR-PBCH, the base station supports the forward compatibility.

Information that may be included in the NR-PBCH will be described. The NR-PBCH may include a UL NR-DRS resource configuration or an NR-PDCCH resource configuration.

The UL NR-DRS resource configuration may be represented in a form of a list. The UL NR-DRS resource configuration list is a set of UL NR-DRS resource indices. The UL NR-DRS resource indices designate radio resources of the UL NR-DRS. Time resources of the UL NR-DRS, which are relative locations to NR-subframes/slots in which the DL NR-DRS is transmitted, may be defined by NR-subframe/slot offsets. Alternatively, indices of the NR-subframes/slots for the UL NR-DRS may be represented by absolute values. In the case in which absolute NR-subframe/slot indices are designated to the terminals, the base station needs to signal NR-system frame numbers (SFNs) to the terminals.

The frequency resources of the UL NR-DRS may include an RB index or a bandwidth. When a bandwidth in which the UL NR-DRS is transmitted is predefined in the specification, the terminal may know the frequency resources for the UL NR-DRS by only the RB index received from the NR-PBCH.

The NR-PDCCH resource configuration may be represented in a form of a list. The NR-PDCCH resource configuration list is a set of NR-PDCCH resource indices. The NR-PDCCH resource indices designate radio resources of the NR-PDCCH. Time resources of the NR-PDCCH may be predefined in the specification, and are in accordance with the method described above. Frequency resources of the NR-PDCCH are in accordance with the configuration method described above. The base station transfers an OFDM symbol index set and a PRB index set in which an NR-PDCCH candidate exists to the terminal, these sets are called as control resource sets. The terminal may monitor one or more control resource sets. The number of NR-DM-RS antenna ports required for decoding the NR-PDCCH may be explicitly included in the NR-PDCCH resource configuration or may be implicitly included in the NR-PBCH. For example, the number of NR-DM-RS antenna ports may be included in the NR-PBCH through a cyclic redundancy check (CRC) mask of the NR-PBCH, and the terminal may perform a blind test to know the NR-DM-RS antenna ports.

The serving base station considers the NR-PBCH and the synchronization signal (for example, the PSS and the SSS) as one unit (for example, a synchronization signal burst) belonging to the same virtual sector to apply the same precoding to the NR-PBCH and the synchronization signal (for example, the PSS and the SSS). That is, a synchronization signal (SS) burst includes the NR-PBCH and the synchronization signal (for example, the PSS and the SSS). The number of SS bursts is determined depending on the number of beams transmitted by the serving base station or precodings, and the determined number of SS bursts are transmitted. The terminal may perform a cell search and an initial access even though it does not know the number of SS bursts. Since the terminal has a less time delay when it increases reception quality of the NR-PBCH while performing a cell search procedure, the terminal may combine NR-PBCHs belonging to several SS bursts as well as one SS burst with each other.

In the case in which the serving base station continuously transmits the SS bursts several times in order to help the terminal perform reception combining, the serving base station may transmit the same redundancy versions (RV) of the NR-PBCHs in different SS bursts (hereinafter, referred to as ‘method PBCH-rv-1’). Alternatively, the serving base station may transmit the different redundancy version RVs of the NR-PBCHs in different SS bursts (hereinafter, referred to as ‘method PBCH-rv-2’).

Method PBCH-rv-1 is a method in which all of the PBCHs transmitted in an SS burst set have the same RV. That is, the NR-PBCHs belonging to the SS bursts transmitted by the base station may have the same RV. The terminal combines the PBCHs having the same RV in spite of being subjected to different precodings with each other. The serving base station may include Z SS bursts in the SS burst set. A transmission periodicity of PBCHs is T₁, and all the RVs of the PBCHs are transmitted one by one at a periodicity of T. In this case, the Z PBCHs belonging to the SS burst set have the same RV. The terminal does not know a value of Z in advance, but assumes that all of successfully detected Z₁ (here, Z₁≤Z) PBCHs have the same RV, and decodes the PBCHs. Through such a process, the terminal may accomplish a delay time less than that of a method of distinguishing PBCHs having the same precoding from each other and combining the Z PBCHs with each other.

The terminal may relatively weakly receive or relatively strongly receive a PBCH to which specific precoding is applied, depending on a radio channel to which the terminal is subjected. Therefore, in the case in which method PBCH-rv-1 is used, a relatively weakly received RV does not give large help to a combining process of the terminal. On the contrary, in the case in which the relatively weakly received PBCH has an RV different from that of the relatively strongly received PBCH, the terminal may use various parity bits in the combining process, and reception quality may be thus further improved.

Method PBCH-rv-2 is a method in which the PBCHs transmitted in an SS burst set have different RVs. That is, the NR-PBCHs belonging to the SS bursts transmitted by the base station may have different RVs. The terminal combines PBCHs subjected to different precodings and having the different RVs with each other. The serving base station may include Z SS bursts in the SS burst set. A transmission periodicity of PBCHs is T₁. In the case in which all the RVs of the PBCHs are transmitted one by one at a periodicity of T, the Z PBCHs belonging to the SS burst set may have the different RVs. The terminal does not know a value of Z in advance, but assumes that successfully detected Z₁ (here, Z₁≤Z) PBCHs successfully detected may have the different RVs, and decodes the PBCHs. The terminal indirectly recognizes values of the RVs that the respective PBCHs have, while receiving the PBCHs. For example, the serving base station may differently use scrambling resources or CRC masking for the PBCHs depending on the RVs. That is, different scrambling resources (or CRC masks) may be applied to the NR-PBCHs belonging to the SS bursts transmitted by the base station. In this case, the terminal may randomly demodulate (for example, blind-demodulate) such a scrambling, and may calculate the RVs on the basis of this result. The serving base station optimizes a combination of the RVs so that the terminal may decode the PBCHs even though the terminal receives the PBCHs corresponding to the different RVs.

The serving base station may encode the PBCHs with respect to 0, 1, 2, and 3, which are the values of the RVs, and map the encoded PBCHs to the respective SS bursts, while transmitting four SS bursts (for example, Z=4). For example, when it is assumed that values of the RVs of SS burst 1 during T are 0, 2, 1, and 3, the serving base station may transmit the four SS bursts (SS bursts 1, 2, 3, and 4) so that values of the RVs of SS burst 2 during T is 2, 1, 3, and 0, values of the RVs of SS burst 3 during T is 1, 3, 0, and 2, and values of the RVs of SS burst 4 during T is T 3, 0, 2, and 1. The terminal detects the Z₁ (here, Z₁≤4) PBCHs in the SS burst set, detects the values of the RVs of the respective PBCHs, and then combines or decodes the PBCHs on the basis of the values of the RVs. Since the terminal receives the different RVs having different qualities, the terminal may obtain a precoding multiplexing gain in the PBCHs.

When the serving base station transmits two SS bursts (for example, Z=2), values of the RVs have 0 and 2 as one RV combination and have 1 and 3 as one RV combination, and the respective RV combinations may be applied per transmission point in time of the SS bursts. Since RV 0 mainly has information bits and RV 3 mainly has parity bits, the terminal may include RV 0 and RV 3 in one SS burst set. Since RV 1 and RV 2 have information bits and parity bits that are appropriately mixed with each other, RV 1 and RV 2 may be included in one SS burst set. For example, when the serving base station assumes that the values of the RV of SS burst 1 during T are 0, 1, 2, and 3, it assumes that the values of the RV of SS burst 2 during T are 2, 3, 0, and 1. Here, in the case in which an order of the RVs is in accordance with gray mapping, RVs in which parity bits are many are continuously transmitted, and RVs in which parity bits are few are continuously transmitted. Therefore, the order of the RVs may be defined in the TS so that combinations of the RVs in which the parity bits are many and combinations of the RVs in which the parity bits are few are alternately transmitted. The terminal may receive the PBCHs of which the values of the RVs are alternated as an odd number and an even number, and may combine and decode the PBCHs with each other on the basis of the values of the RVs. Since the terminal receives the different RVs having different qualities, the terminal may obtain a precoding multiplexing gain in the PBCHs.

An NR-SIB transmission method for a case in which method C1 and method C2 are used will be described. Method C1 corresponds to a case in which locations of the NR-PDCCH resources are defined by the specification. Method C2 corresponds to a case in which locations of the NR-PDCCH resources is allowed to be configured. An NR-SIB transmission method for method C2 is divided into method C2-1 and method C2-2 depending on an NR-PBCH transmission method, and method C2-1 and method C2-2 will be described, respectively. In addition, NR using both of method C1 and method R2 does not need to transmit the NR-PBCH.

An NR-SIB transmission method in the case of using method C1 will be described. The base station periodically transmits the DL NR-DRSs. The base station periodically transmits the NR-PBCHs using the DL NR-DRS antenna ports. In the case in which method T1 is used, the base station transmits separate DL NR-PBCHs per virtual sector. In the case in which method T2 is used, the base station transmits the same DL NR-PBCH without distinguishing the virtual sectors from each other. Precoding of the DL NR-DRS antenna ports is not defined in the specification, but is implemented by the base station. The base station may precode the DL NR-DRS resources like the virtual sectors. The base station may transmit the DL NR-DRS resources like the number of virtual sectors.

The terminal may receive the DL NR-DRSs even though it does not receive configuration information of the DL NR-DRSs in advance. The terminal performs cell detection through blind detection even though it does receive the number of DL NR-DRS resources in advance. In the case in which the terminal successfully receives a specific DL NR-DRS, the terminal demodulates the NR-PBCH using a DL NR-DRS antenna port receiving the specific DL NR-DRS. In the case in which method R2 is used, the configuration information of the UL NR-DRSs is included in the NR-PBCHs. Since the terminal estimates an index i of a virtual sector to which the terminal belongs from the received DL NR-DRS resources, the terminal selects an i-th UL NR-DRS resource, and transmits the UL NR-DRS using the selected resource. Although the precoding of the terminal needs to be applied to the UL NR-DRS, the precoding of the terminal is not defined by the specification, but is performed by implementation of the terminal. The terminal may reuse a linear filter for receiving the DL NR-DRS to apply the linear filter to the UL NR-DRS.

The base station may implicitly know the index i of the virtual sector to which the terminal belongs when it receives the UL NR-DRS from the terminal. The base station starts to transmit an NR-PDCCH corresponding to the i-th virtual sector. In the case in which method T1 is used, the base station transmits separate NR-PDCCHs per virtual sector. In the case in which method T2 is used, the base station transmits the same NR-PDCCH without distinguishing the virtual sectors from each other. The NR-PDCCHs are transmitted by the base station on the basis of the NR-DM-RS antenna ports. The NR-DM-RS resources are subjected to the precoding and are then transmitted. A precoding method used in this case may be performed through implementation. The base station may reuse the linear filter used to demodulate the UL NR-DRSs received from the terminal. Since the NR-PDCCHs are transmitted in locations of resources predefined by the specification, the terminal is not informed of separate resource information of the NR-PDCCH. The terminal detects a DL scheduling assignment in the NR-PDCCH. The terminal detects assignment information of the NR-PDSCH from the detected DL scheduling assignment information. Since the NR-PDSCH includes the NR-SIB, the terminal may decode the NR-SIB. Information included in the NR-SIB may recognize an SFN, a system bandwidth, physical layer cell identification information, and the like. In addition, scheduling information for receiving system information for establishing the NR-RRC connection may be received by the terminal.

An NR-SIB transmission method in the case of using method C2-1 will be described.

The base station periodically transmits the DL NR-DRSs. The base station periodically transmits NR-MIB type 1 through the NR-PBCH using the DL NR-DRS antenna ports. As a method of transmitting the NR-PBCH, the same method as the method of transmitting the NR-PBCH described above in method C1 is used. In the case in which method T1 is used, the base station transmits separate DL NR-PBCHs per virtual sector. In the case in which method T2 is used, the base station transmits the same DL NR-PBCH without distinguishing the virtual sectors from each other. In the case in which method R2 is used, NR-MIB type 1 included in the DL NR-PBCH includes configuration information of the UL NR-DRS resources. When the terminal selects a specific resource and transmits the UL NR-DRS, the base station starts to transmit the NR-PBCH and then starts to transmit the NR-PDCCH. In the case in which method T1 is used, the base station transmits separate NR-PBCHs and separate NR-PDCCHs per virtual sector. In the case in which method T2 is used, the base station transmits the same NR-PBCH and the same NR-PDCCH without distinguishing the virtual sectors from each other. The base station transmits the NR-PBCHs using the NR-DRS antenna ports, and uses resources distinguished from DL NR-DM-RS antenna port-based NR-PDCCHs. A precoding method determined through implementation by the base station is applied to the NR-DM-RS and the NR-DRS. In the case in which method C2 is used, information included in the NR-PBCH is NR-MIB type 2. NR-MIB type 2 includes configuration information of the NR-PDCCH resources. NR-MIB type 2 explicitly or implicitly includes locations of NR-subframes/slots in which the NR-SIBs are transferred. For example, NR-MIB type 2 includes SFN information, and the terminal may estimate the NR-subframes/slots in which the NR-SIBs are received. The NR-PDSCHs including the NR-SIBs have a periodicity defined by the specification.

The terminal decodes the NR-PDCCHs using the NR-DM-RS antenna ports to detect scheduling assignment information for the NR-PDSCHs. The terminal decodes the NR-PDSCHs to obtain the NR-SIBs. The NR-SIBs include direct information for establishing NR-RRC connection and indirect information. As in LTE, the NR-SIBs may also be configured to have different periodicities depending on contents thereof. Method C2-1 may be modified and be then applied to an NR-SIB transmission method of NR (for example, 6 GHz or less) operated in a low frequency band. That is, in the NR-SIB transmission method (for example, procedures for 6 GHz or more) described above, transmission of NR-MIB type 1 and transmission of the UL NR-DRS may be excluded. That is, NR-SIB procedures similar to each other may be used in terms of band agnostic.

An NR-SIB transmission method in the case of using method C2-2 will be described.

The base station periodically transmits the DL NR-DRSs. The base station periodically transmits NR-MIBs through the NR-PBCH using the DL NR-DRS antenna ports. As a method of transmitting the NR-PBCH, the same method as the method of transmitting the NR-PBCH described above in method C1 is used. In the case in which method T1 is used, the base station transmits separate DL NR-PBCHs per virtual sector. In the case in which method T2 is used, the base station transmits the same DL NR-PBCH without distinguishing the virtual sectors from each other. Configuration information of the NR-PDCCH resources is included in the NR-MIB. In the case in which method R2 is used, the NR-MIB further includes configuration information of the UL NR-DRS resources to include both of the configuration information of the NR-PDCCH resource and the configuration information of the UL NR-DRS resources. In method C2-2, an amount of information possessed by the NR-MIB may be more than that in method C1 or method C2-1, but the terminal may more rapidly establish the NR-RRC connection.

The terminal receives the DL NR-DRSs, and selects a virtual sector i corresponding to one NR-DRS resource. The terminal transmits the UL NR-DRS using the i-th UL NR-DRS resource.

The base station recognizes existence of the terminal using the UL NR-DRS received from the terminal, and starts to transmit the NR-PDCCH. In the case in which method T1 is used, the base station transmits separate NR-PBCHs and separate NR-PDCCHs per virtual sector. In the case in which method T2 is used, the base station transmits the same NR-PBCH and the same NR-PDCCH without distinguishing the virtual sectors from each other. The base station transmits the NR-PDCCHs through implemented precoding using the NR-DM-RS antenna ports.

The terminal decodes the NR-PDCCH from a DL NR-subframe/slot after transmitting the UL NR-DRS.

The base station may transmit the NR-SIB to the terminal using the NR-PDSCH. Direct information for establishing the NR-RRC connection and indirect information as well as an SFN, a system bandwidth, and the like, may be included in the NR-SIB.

Hereinafter, an operation of an idle terminal will be described.

The idle terminal may receive the NR-PDCCH using the NR-MIB.

If the base station does not transmit the NR-PDSCH when it does not receive the UL NR-DRS, the idle terminal may not receive the NR-SIB transmitted by the base station using the NR-PDSCH. Since the NR-SIB includes at least cell selection/reselection, a public land mobile network (PLMN) identification list, and cell barring information, the idle terminal may not decide whether or not it may be associated with the corresponding NR cell. Therefore, the idle terminal transmits the UL NR-DRS to induce the base station to transmit the NR-SIB in the NR-PDCCH and the NR-PDSCH. However, when the idle terminal transmits the UL NR-DRS, a power is consumed in direct proportion to the number of NR-cells that are observed. In order to reduce the consumed power, the terminal may observe whether or not the NR-SIB included in the NR-PBCH described above is transmitted (for example, whether or not NR-SIBs that are to be applied per virtual sector are transmitted). Through this, the base station may adjust a bit field of the NR-PBCH even though only one of other terminals belonging to the same virtual sector as a virtual sector to which the idle terminal belongs transmits the UL NR-DRS.

When the base station notifies the terminal of transmission of the NR-SIB through the NR-PBCH, a terminal that intends to receive the NR-SIB among terminals belonging to the corresponding virtual sector observes the NR-PDCCH in continuous downlink subframes/slots after the NR-PBCH. As a monitoring window for the idle terminal, a subframe/slot window defined in the specification may be used. Alternatively, the terminal may observe the NR-PDCCH in all the subframes/slots allowed by discontinuous reception (DRx) before it receives the next NR-PBCH.

Hereinafter, RRM measurement performed by the terminals will be described.

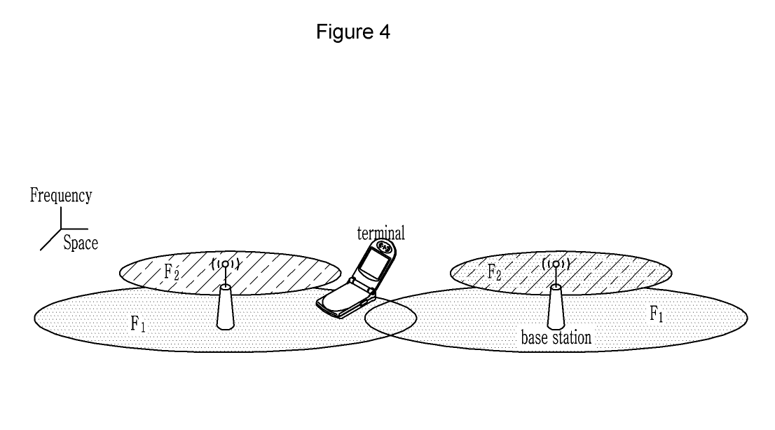

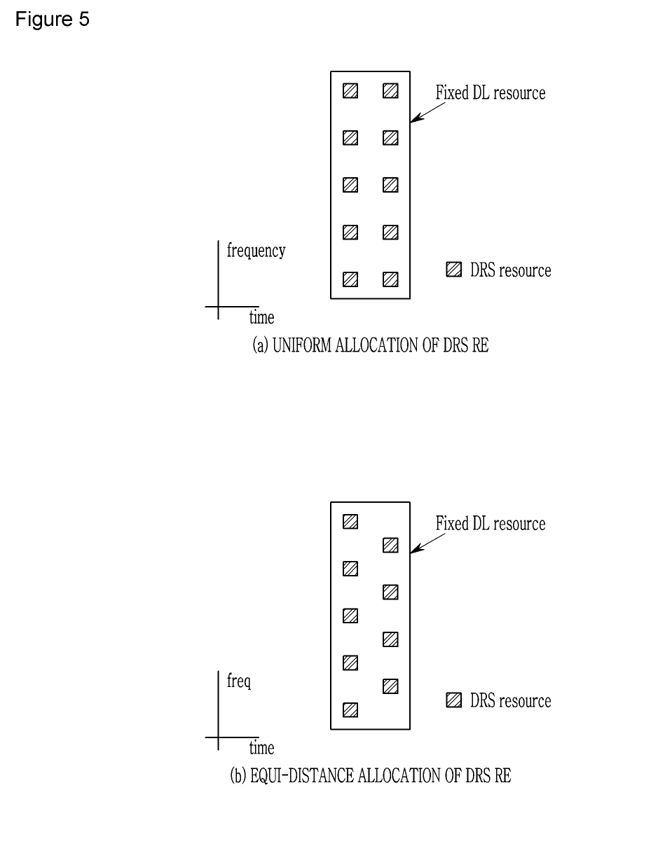

FIG. 4 is a view showing a scenario for RRM measurement performed by a terminal according to an exemplary embodiment of the present invention. In addition, FIG. 5 is a view showing RE mapping of DL new radio-discovery reference signal (NR-DRS) resources according to an exemplary embodiment of the present invention.

A plurality of base stations and a terminal exist. One base station has a plurality of cells, and the respective cells are deployed at different frequencies (for example, F₁ and F₂). In FIG. 4, four cells are shown. The terminal performs RRM measurement for the four cells.

The terminal does not perform the RRM measurement in all the subframes/slots. The TS defines a periodicity of fixed DL resources including the DL NR-DRS resources transmitted by the base station and the subframe/slot offsets. The terminal may know whether or not a specific subframe/slot includes the DL NR-DRS resources from the periodicity and the subframe/slot offsets that are already known. The terminal may know the subframe/slot including the DL NR-DRS resources through a configuration of the base station or reception of a physical layer signal, and performs the RRM measurement in only the corresponding subframe/slot.

The fixed DL resources may also consist of adjacent resource elements (REs) that may be represented by a localized time and a localized frequency. Alternatively, the fixed DL resources may consist of REs that are not adjacent to each other in order to obtain diversity.

The DL NR-DRS resources are a subset of fixed DL resources, and consist of REs that are distributed in a state in which they are spaced apart from each other in order to obtain the diversity. The DL NR-DRS resources may be distributed in several forms in the fixed DL resources. The DL NR-DRS resources mean all the DL NR-DRS antenna ports transmitted by the serving base station, and the number of DL NR-DRS resources may be one or more.

A uniform allocation for DL NR-DRS REs is shown in (a) of FIG. 5, and an equi-distance allocation for DL NR-DRS REs is shown in (b) of FIG. 5.

As shown in (a) of FIG. 5, in RE mapping of DL NR-DRS resources, several symbols and the same subcarrier may be used within a fixed DL resource.

Alternatively, as shown in (b) of FIG. 5, in RE mapping of DL NR-DRS resources, several symbols and several subcarriers may be used within a fixed DL resource.

As shown in (a) of FIG. 5, in the case in which the same subcarrier and adjacent symbols are used in the RE mapping for the DL NR-DRS, when spreading codes are used in a time domain, different DL NR-DRS antenna ports or DL NR-DRS antenna ports from different serving base stations may be multiplexed. Since a reception power gain may be obtained through this, (a) of FIG. 5 may be utilized to extend a DL coverage.

As shown in (b) of FIG. 5, in the case in which the RE mapping for the DL NR-DRS is performed so that subcarriers maintain a predetermined distance per symbol within the fixed DL resource, the RE mapping for the DL NR-DRS has a lower channel estimation error in a time domain and a frequency domain. In the case in which the terminal demodulates a physical channel belonging to the fixed DL resource, the terminal may easily use predetermined interpolation for performing channel estimation on arbitrary REs. In the case in which the terminal demodulates the PBCH, or the like, using the DL NR-DRS, RE mapping having a form similar to that of the RE mapping shown in (b) of FIG. 5 may be performed.

Meanwhile, the fixed DL resource means a physical signal and a physical channel transmitted regardless of a subframe/slot type. The fixed DL resource includes at least the DL NR-DRS, a synchronization signal, and an NR-master information block (NR-MIB). In the case in which the physical signal and the physical channel are not periodically transmitted or are intermittently transmitted (for example, on-demand or event-driven), they may not be included in the fixed DL resource. Amounts of such an aperiodic physical signal and physical channel are proportional to a DL load. As an example, a control channel associated with DL scheduling assignment of a terminal-specific beamformed PDCCH (for example, a UE-specific beamformed PDCCH) and a terminal-specific beamformed enhanced physical downlink control channel (EPDCCH) (for example, a UE-specific beamformed EPDCCH) is included in the fixed DL resource. As another example, the fixed DL resource includes a terminal-specific PDSCH (for example, a UE-specific PDSCH). As yet another example, in the case in which a system information block (SIB) is transmitted through the PDSCH, the SIB and a common search space (CSS) of the PDCCH scheduling the SIB are included in the fixed DL resource. As yet another example, a paging channel is included in the fixed DL resource. As yet another example, a physical multicast channel (PMCH) is included in the fixed DL resource. Such a method of classifying the physical signal and the physical channel may be used regardless of a numerology or regardless of the number of symbols constituting a TTI.

Since 3GPP NR TDD reference system 1 may change subframe/slot types per subframe/slot, the terminal may not know existence of GPs in advance, and may not know locations of the GPs in the subframes/slots in advance. As a method of allowing the terminal to know the existence of the GP, the terminal may decode the NR-PDCCH in the corresponding subframe/slot to receive DL assignment, thereby deciding that the corresponding subframe/slot is a DL subframe/slot or a DL-centric subframe/slot. The latter case corresponds to a case in which the GP is defined in the DL-centric subframe/slot. Alternatively, the terminal may receive an UL grant to decide that the corresponding subframe/slot is a UL subframe/slot or a UL-centric subframe/slot. Alternatively, the terminal may receive an UL grant and receive a starting symbol index and an ending symbol index of an UL data region to indirectly decide that the GP exists in the corresponding subframe/slot and a location of the corresponding GP.

In the case in which the terminal does not receive the DL assignment and the UL grant in the corresponding subframe/slot, it is difficult to know a subframe/slot type of the serving cell. In the case of a wireless communication system operated in the TDD, the subframe/slot type corresponds to one of the DL subframe/slot, the DL-centric subframe/slot, the UL subframe/slot, the UL-centric subframe/slot, and a special subframe/slot. In the case in which the subframe/slot type corresponds to the special subframe/slot, the terminal may know the number of symbols belonging to the DL region.

In this case, method IND1 and method IND2 may be considered.

In method IND1, the serving cell includes a subframe/slot type indicator (STI) indicating the subframe/slot type in the fixed DL resource. Method IND1-1, method IND1-2, and method IND1-3 for method IND1 may be considered.

Method IND1-1 corresponds to a case in which a physical subframe/slot type indicator channel (PSTICH) including the STI is separately defined by the TS. Method IND1-1 may explicitly inform the terminal of a cell-specific type. To this end, the RE needs to be additionally used, but the terminal may easily know the corresponding subframe/slot type in spite of such an overhead. Particularly, the terminal performing the inter-frequency RRM measurement may know whether the corresponding subframe/slot is the DL subframe/slot (for example, the UL region does not exist), the DL-centric subframe/slot, the UL subframe/slot (for example, the DL region does not exist), the UL-centric subframe/slot, or the special subframe/slot by only the STI of the fixed DL resource, and such a DL region may thus be utilized for the RRM measurement. In this case, the STI needs to transfer the number of cases of five. However, in the case in which the STI is defined in order to simply change an algorithm performing the RRM measurement, it is sufficient for the STI to transfer the number of cases of two. Here, the number of cases of two may mean whether minimum resources over a symbol and a frequency domain for the terminal (for example, a symbol and a frequency domain predefined by the TS or preconfigured by the base station) are included or are not included in the DL region of the subframe/slot. In this case, the STI may transfer only one bit.

As another method, a length of the DL region may be encoded in the STI. The number of symbols additionally assigned as the DL region after the fixed DL resource may be defined by the TS in some cases. For example, the STI may transfer the number of cases of four, a first case may show 0, a second case may show 4, a third case may show 8, and a fourth case may show 12. The STI may signal the number of DL symbols to a plurality of unspecific terminals using two bits.

The STI may also transfer slot types subdivided into three cases or more to the terminals. In this case, the terminals may not only support CSI feedback or the RRM measurement that needs to recognize the DL region, but may also support a scenario that needs to recognize the UL region. For example, an operation of the terminal configured from the serving base station so as to measure UL interference signals from neighboring base stations may be considered. In the case in which the serving base station is operated in the dynamic TDD, the serving base station may configure the terminal to perform measurement on DL interference signals and the UL interference signals from the neighboring base stations. Here, the measurement may mean the CSI measurement, the RRM measurement, or the CSI and RRM measurement. In this case, the terminal needs to know information on UL regions as well as DL regions of the neighboring base stations, which may be obtained from STIs included in PSTICHs transmitted by the neighboring base stations.

The PSTICH may obtain frequency diversity through encoding using several REs in the fixed DL resource.

The PSTICH belongs to the fixed DL resource in which the DL NR-DRS resource is defined. In the subframe/slot in which the DL NR-DRS resource is not transmitted, the STI for the RRM measurement does not need to be transmitted. However, in the case in which a very short processing time is required, it is advantageous that the terminal knows the subframe/slot type or the STI at a significantly rapid point in time in advance, and it is advantageous that the terminal knows subframe/slot types and STIs of adjacent cells. In this case, the PSTICHs may be transmitted per subframe/slot. In the case in which the base station transmits the PSTICHs per subframe/slot, the PSTICHs may include at least time and frequency locations of blank resources and the number of symbols having DL control channels as well as the subframe/slot types. Here, the blank resources may have a unit of a subband and a mini-slot.

Time locations and frequency locations of the PSTICH resources are defined by the TS, and the terminal (for example, RRC_IDLE UE) that is not RRC-connected to the base station, a non-serving terminal, and the like, may also perform the measurement.

The PSTICH is transmitted through a single antenna port, and the terminal needs to receive the PSTICH using a cell-specific antenna port. A separate DM-RS for the PSTICH may be introduced in an NR cell. Alternatively, the NR cell may modulate the PSTICH using an antenna port for a common search space (CSS) of the PDCCH. The PSTICH and the PDCCH do not use different DM-RSs, and the terminal may reuse a DM-RS for the PDCCH in order to demodulate the PSTICH. On the other hand, in the case in which a DM-RS for demodulating the PSTICH and a DM-RS for demodulating the PDCCH are distinguished from each other and different antenna ports are used, the serving base station needs to transmit more DM-RSs, which is disadvantageous in terms of resource efficiency.

The PSTICH needs to be also detected by a terminal in an RRC idle (RRC_IDLE) state, RRC-connected terminals belonging to the neighboring base stations, or the like. Therefore, in order for the terminal that is not RRC-connected to the serving base station or the terminals belonging to the neighboring base stations to detect the PSTICH, the serving base station may include DM-RSs of which an amount is more than that of DM-RSs transmitted for only serving terminals in an RRC-connected state in the PSTICH and then transmit the PSTICH. Therefore, in order to minimize additional transmission of PSTICH DM-RSs, the same precoding as precoding for the PDCCH DM-RSs transmitting the CSSs may be applied to the PSTICH. In this case, the serving base station may transmit the PSTICH and PDCCH utilizing the same frequency band or alternately interleaved frequency resources (for example, the PSTICH uses odd REG indices and the PDCCH uses even REG indices). In this case, the terminal may assume that the CSS of the PSTICH and the CSS of the PDCCH use the same antenna port.

In the case of the PSTICH, in order for the terminals to have higher reception quality (for example, a lower error ratio), additional DM-RSs may be transmitted or a lower encoding ratio may be applied to subframe/slot type indicators (STIs). In order to apply the lower encoding ratio to the STIs, encoded STIs may be mapped to a larger amount of time and frequency resources. Since the STI needs to be utilized at a rapid point in time of the subframe/slot, the serving base station may use a smaller amount of time to use a larger amount of frequencies without increasing latency for demodulation of the terminal. Through this, a frequency multiplexing gain may also be obtained.

The PSTICHs may be allowed to have different values per virtual sector. In this case, the PSTICHs may be separately transmitted per virtual sector. In the case in which the PSTICHs are cell-specifically transmitted, all the slot types that each virtual sector needs to have may be included in cell-specific PSTICHs.

Method IND1-2 corresponds to a case in which the PSTICH is included in the NR-PDCCH. For example, the base station may generate an STI indicating a subframe/slot type, include the STI in the NR-PDCCH, and transmit the NR-PDCCH to the terminal through the fixed DL resource. The terminal searches the STI in a common search space or a cell-specific search space (CSS) of the NR-PDCCH. In this case, since the terminal needs to search a separate PDCCH candidate, the terminal needs to perform demodulation of the PDCCH in order to perform the RRM measurement. To this end, the terminal is more complicatedly operated, and method IND1-2 is thus more disadvantageous than method IND1-1. In method IND1-2, the meaning of the STI and a method of configuring the DM-RS are the same as those in method IND1-1.

In order to reduce complexity of the terminal, the terminal needs to recognize locations of time and frequency resources of the STI without randomly (for example, blind decoding) searching a search space of the PDCCH. To this end, an operation such as separate scrambling for an REG (or a CCE) including the STI among REGs (or CCEs) belonging to the PDCCH may not be performed.

For example, REGs (or CCEs) are separately assigned as some resources of the PDCCH, and the REGs (or the CCEs) may include at least information of the STI and may further include information such as blank resources, reserved resources, or the like. That is, the base station may transmit the STI using an REG (or a CCE) corresponding to identification information of the base station among REGs (or CCEs) belonging to the fixed DL resource (or the PDCCH resource). The terminal may infer frequency and time resources of some resources of the PDCCH by oneself depending on the identification information of the serving base station (or the serving cell). Since resources for transmitting the STI may be changed depending on the identification information of the serving base station (or the serving cell), collision between STIs transmitted by different base stations (or cells) may be avoided.

Therefore, the terminal may recognize the STI of the serving base station or the STI of the neighboring base station, and perform an operation such the RRM measurement, the CSI measurement, or the like, as configured from the serving base station.

Since the REG or the CCE is used in a method of transmitting the STI as a portion of the PDCCH, the serving base station may perform REG mapping (or CCE mapping) for other PDCCH candidates while avoiding the REG (or the CCE) for transmitting the STI. As an example, the serving base station performs mapping for constituting the CCE using REGs other than the REG for transmitting the STI among the REGs, and then maps the PDCCH candidates to the already generated CCEs. That is, the serving base station may map the PDCCH candidates to the REGs other than the REG for transmitting the STI among the REGs belonging to the fixed DL resource. Therefore, in the case in which the serving base station performs indexing (or numbering) of the REGs constituting the CCE, the serving base station performs the indexing using only the REGs to which the STI is not mapped and constitutes the CCE. As another example, the serving base station may perform the indexing using only CCEs other than the CCE for transmitting the STI among the CCEs. Then, the serving base station performs mapping for the PDCCH candidates.

An example of designing the PSTICH will be described.

As a method of defining the PSTICH, method STI-1 may be used as in an LTE PCFICH, or method STI-2 may be used as in an LTE PDCCH.

In method STI-1, the PSTICH is designed similarly to the LTE PCFICH. The serving base station processes an encoded STI in an REG unit (or a CCE unit), and maps the encoded STI to an REG (or CCE) location defined by the TS or a resource that may be inferred from the identification information of the serving base station (or the serving cell) in the REG unit (or the CCE unit).

In order for the terminal to demodulate the STI at a more rapid point in time, the REG or the CCE including the STI may be located in a first DL symbol. For example, the base station may locate the REG (or the CCE) for transmitting the STI in a forefront time domain symbol of time domain symbols belonging to the subframe/slot.

In order to raise decoding performance of the STI, the serving base station may map the REGs or the CCEs including the STI over several frequencies. For example, the serving base station may map the REGs or the CCEs for transmitting the STI to a plurality of frequencies belonging to a system bandwidth. Through this, a frequency diversity gain may be obtained

In method STI-2, the PSTICH is included in a cell-specific search space of the PDCCH.

The PSTICH includes at least information for knowing the number of DL symbols. For example, in the case in which the serving base station constitutes one subframe/slot using x (here, x=7 or 14) symbols and the number of DL symbols existing in one subframe/slot is y (here, y<x), the serving base station needs to inform the terminal of a value of y. For example, the serving base station may determine the number (y) of time domain symbols for the DL among x time domain symbols belonging to the subframe/slot, determine a subframe/slot type, and transmit the PSTICH including the determined number (y) and the determined subframe/slot type (or the STI) through the CSS for the PDCCH. There, y and the STI may be encoded and be included in the PSTICH in an index form.

The terminal may interpret that (x-y) symbols correspond to GP or UL symbols. The terminal may receive the PSTICH to recognize that the corresponding symbols are the UL symbols or the GP symbols. The terminal performs reception and transmission in accordance with the DL assignment and the UL grant of the base station, and may utilize y symbols for the DL measurement (for example, the RRM measurement, the CSI measurement, or the like).

The terminal performing the inter-frequency measurement or the terminal in the RRC idle state as well as the terminal in RRC-connected state, belonging to the serving base station (or the serving cell), may decode the PSTICH. Through this, the terminal may know the value of y. For example, the terminal may measure an appropriate RSSI for the serving base station (for the serving cell) using the value of y.

In order for the terminal to demodulate the STI at a more rapid point in time, the REG (the REGs) or the CCE (CCEs) including the STI may be located in a first DL symbol. For example, the base station may locate at least one REG (or CCE) for transmitting the STI among the REGs (or the CCEs) belonging to the PDCCH resources in a forefront symbol of the y DL symbols.

In order to raise decoding performance of the STI, the serving base station may map the REGs or the CCEs including the STI over several frequencies. For example, the serving base station may map at least one REG (or CCE) for transmitting the STI among the REGs (or the CCEs) belonging to the PDCCH resources to a plurality of frequencies within a system bandwidth. Through this, a frequency diversity gain may be obtained.

The serving base station processes the encoding STI in the CCE unit (or the REG unit), and maps the encoded STI to the REG location (or the CCE location) defined by the TS in the CCE unit (or the REG unit) or maps the encoded STI in the resource that may be inferred from the identification information of the serving base station (or the serving cell) in the CCE unit (or the REG unit). As an example, the terminal may infer a location of system information (for example, an SIB) belonging to an SS burst from the identification information of serving base station (or the serving cell), and may demodulate the SIB to know a location of the STI. As another example, the STI may be mapped to a resource determined on the basis of the identification information of serving base station (or the serving cell). As yet another example, the STI may be transmitted in a resource determined by the TS.

In method IND1-3, reception strength of the DL NR-DRS antenna port may be increased by a spreading factor using code division multiplexing (CDM) in the DL NR-DRS resources. For example, the LTE CSI-RS or the LTE DM-RS may increase reception strength of the terminal using CDM-2 and CDM-4. Each orthogonal cover code (OCC) applied to the CDM corresponds to one antenna port.

In the case in which a subframe/slot type of the DL NR-DRS subframe/slot is the DL-centric subframe/slot, a specific OCC (for example, OCC₁) is applied to each DL NR-DRS resource. In the case in which a subframe/slot type of the DL NR-DRS subframe/slot is the UL-centric subframe/slot, another OCC (for example, OCC₂ different from OCC₁) is applied to the DL NR-DRS resource. Since the terminal may estimate the OCC applied to the DL NR-DRS resource, the terminal may know the subframe/slot type of the corresponding DL NR-DRS subframe/slot. This is a method in which a 3GPP NR cell performs implicit indication through the DL NR-DRS resource without defining a separate physical channel.

In detail, in the case in which the DL NR-DRS resource consisting of several (for example, L) DL NR-DRS REs is defined by the TS, the NR cell may use an L-length OCC. The subframe/slot type may be determined depending on the OCC detected by the terminal. As an example, in the case in which L=2, the terminal may detect [+1, +1] to decide that the subframe/slot type is the DL-centric subframe/slot. As another example, the terminal may detect [+1, −1] to decide that the subframe/slot type is the UL-centric subframe/slot.

Method IND2 is a method in which the terminal recognizes a subframe/slot type without separate indication.

In method IND2-1 for method IND2, the terminal may guess the subframe/slot type depending on a feature of the subframe/slot type for the 3GPP NR TDD.

In the case in which the subframe/slot type is the DL-centric subframe/slot, the GP is not defined or a location of the GP includes a final symbol of the subframe/slot. In the case in which the subframe/slot type is the UL-centric subframe/slot, a symbol located after the fixed DL resource and the next symbol (symbols) belong to the GP. In the case in which the subframe/slot type is the special subframe/slot, DL symbols of which the number is non-zero are located after the fixed DL resource, the GP is located after the DL symbols, and the UL region is located after the GP. Therefore, the terminal may detect the location of the GP to determine the subframe/slot type. As a method of detecting the location of the GP, a method in which the terminal performs energy detection may be used.

Since base stations geographically adjacent to each other need to be time-synchronized with each other and be operated in the 3GPP NR TDD, the terminal may assume that DL data transmission depending on a scheduling assignment or UL data transmission depending on a scheduling grant is not present in resources belonging to the GP. In the resources belonging to the GP, relatively less energy is received than in the DL region or the UL region. Therefore, the terminal performs energy detection per symbol to detect the location of the GP.

When it is assumed that an energy value detected by the terminal in the next symbol of a symbol including the fixed DL resource is E₁, energy values detected by the terminal by repeating such a process may be represented by, [E₁, E₂, . . . , E_{L}]. Here, L is a natural number, and corresponds to a symbol index that belongs to the subframe/slot, but does not include the fixed DL resource.

In order to detect existence of the GP of which a length is not known, the terminal may compare S_{L}=Σᵢ₌₁^{L-1}Eᵢ/(L−1) and a value of E_{L} with each other. When a region including the corresponding symbol is the DL region, interference hypothesis are the same as each other, and thus, a value of S_{L} corresponding to a partial average is not significantly different from E_{L}. When the region including the corresponding symbol and a region corresponding to the partial average are different from each other, a value of S_{L} may be significantly different from E_{L}. The terminal may detect the existence of the GP depending on a result of such a change detection in one symbol.

In order to lower false alarm probability, the terminal may perform hypothesis testing using a larger number of symbols. The terminal may sort (or group) symbols into the GP and the UL region in the UL-centric subframe/slot. The terminal may sort (or group) symbols into the DL region or sort (or group) symbols into the DL region and the GP in the DL-centric subframe/slot. [E₁, E₂, . . . , E_{M}] may be divided into two or less groups. Here, M indicates a maximum value of L. A boundary in the case in which [E₁, E₂, . . . , E_{M}] is divided into two groups corresponds to 1. Since the terminal utilizes all of M+1 values after storing the entirety of one subframe/slot in a data buffer in order to utilize all of the M+1 values, latency corresponding to a length of the subframe/slot is generated. However, since only energy values are stored (that is, (M+1) values are stored), an amount of data is not much. In addition, in the case in which the detection of the location of the GP is utilized for the RRM measurement, the latency corresponding to the length of the subframe/slot is negligibly small.

However, there are several scenarios in which an index of the GP symbol may not be accurately detected. As an example, there is a case in which a direction in which the terminal intending to detect the subframe/slot type is located is nulled by precoding selected by a cell scheduler. In the case, even though it is assumed that the terminal is located at the cell center, non-trivial energy is radiated in the DL region, and even though the terminal receives the non-trivial energy, the terminal may collect small energy. As another example, there is a case in which the terminal intending to detect the subframe/slot type is located at a cell edge. In this case, a received energy level may not be significantly different from a noise level due to path loss. In this case, the terminal may misdetect the GP. As yet another example, there is a case in which an amount of DL data in the data buffer is small. In this case, the scheduler does not radiate energy even though the terminal is located at the cell center, and thus, the terminal may not collect much energy. In this case, it is difficult for the terminal to detect the existence of the GP. In the case in which a predetermined large difference (for example, an offset greater than a threshold) is not present in sufficient statistics obtained from the hypothesis testing, the terminal may not decide the existence of the GP, and the terminal may not determine the subframe/slot type of the corresponding subframe/slot.

When cell association is based on a load condition, control plane latency may be reduced. A case in which the base station has several frequency allocations and operates several system carriers is considered. This corresponds to a case in which cells having different frequencies are operated in the same site.

The terminal performs the RRM measurement for the respective cells. In the case in which the terminal measures RSRPs for the respective cells without a separate configuration, the terminal may measure a larger RSRP for a cell (for example, cell 1) deployed at a low frequency. In the case in which transmission powers are the same as each other, path loss at a low frequency is less than that at a high frequency, and the terminal may thus obtain the larger RSRP for the cell (cell 1) in the same site. In this case, the terminal tends to initially access the cell (cell 1). However, this is irrelevant to a traffic load condition of the cell, and since the RSRP corresponds to a function about a propagation arrival distance between the terminal and the cell, even though a traffic load of the cell is large, the serving base station associates the corresponding terminal with the corresponding cell. Then, the serving base station performs load balancing to signal handover commands for handing over some of the serving terminals to a cell (for example, cell 2) deployed at a high frequency. These operations consume much control plane latency. The eMBB scenario is not significantly affected by the control plane latency, but the control plane latency needs to be reduced in the URLLC scenario. Therefore, the terminal may search a cell having a low load and then perform a cell selection procedure and a cell reselection procedure.

The terminal belonging to the RRC idle (RRC_IDLE) state may measure a load of the cell.

The terminal in the RRC connected (RRC_CONNECTED) state is operated in the RRC idle (RRC_IDLE) state after a DRx cycle configured from the serving cell or a predetermined time defined by an RRC connection timer, when a session ends. Then, when a DL session is again generated, the serving cell base station searches the terminal through paging, and when an UL session is generated, the terminal performs an initial access in a camped-on cell. Since the terminal in the RRC idle (RRC_IDLE) state determines a camping cell on the basis of the RSRP or the RSRQ, it tends to select the cell (for example, cell 1). However, since this does not sill consider the load, handover by the load balancing needs to be frequently performed, resulting in an increase in the control plane latency. Therefore, in order to actively support the URLLC, the terminal may reflect a DL load to perform a cell selection procedure, and may also reflect an UL load to perform a cell selection procedure.

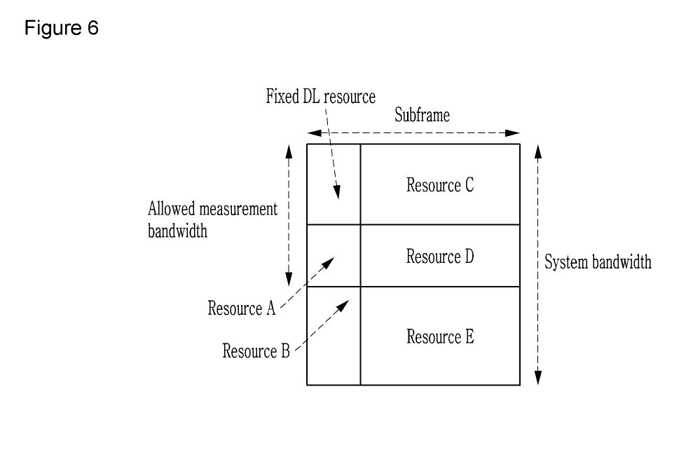

FIG. 6 is a view showing a resource possessed by a 3GPP NR reference system in one subframe/slot. In detail, in FIG. 6, a case in which the resource is divided into six resources (for example, a fixed DL resource, resource A, resource B, resource C, resource E, and resource E) is shown. In FIG. 6, a horizontal axis indicates a subframe, and a vertical axis indicates a system bandwidth.

In FIG. 6, a DL region and a UL region are not distinguished from each other. A time boundary and a frequency boundary between the resources will be described on the basis of a numerology used by the fixed DL resource.

In FIG. 6, the fixed DL resource includes information such as a synchronization signal, a DL NR-DRS, a PDCCH, a PBCH, and the like. This information corresponds to necessary information for a standalone operation. The fixed DL resource uses one numerology defined by the TS. The DL resource may consist of a set of adjacent REs. Alternatively, the fixed DL resource may be configured so that RE sets are not adjacent to each other in a frequency axis in order to obtain diversity.

In FIG. 6, resource A consists of symbols including the fixed DL resource, and consists of subcarriers that belong to a measurement bandwidth allowed to the terminal, but do not belong to the fixed DL resource. The fixed DL resource and resource A may use different numerologies. In the case in which half-duplex is used in the 3GPP NR, resource A belongs to the DL resource.

In FIG. 6, resource B consists of resources that do not belong to a measurement bandwidth among resources that belong to the symbols including the fixed DL resource. The fixed DL resource and resource B may use different numerologies. In the case in which half-duplex is used in the 3GPP NR, resource B belongs to the DL resource.

In FIG. 6, resource C uses the same subcarriers as subcarriers for the fixed DL resource, but uses symbols different from symbols for the fixed DL resource. The fixed DL resource and resource C may use different numerologies. In the case in which the GP is included in a subframe/slot type, some of resource C belongs to the GP, and the other of resource C belongs to the UL region.

In FIG. 6, resource D consists of resources belonging to subcarriers that are not used by the fixed DL resource among subcarriers belonging to the measurement bandwidth, and consists of resources belonging to symbols that are not used by the fixed DL resource. The fixed DL resource and resource D may use different numerologies. In the case in which the GP is included in a subframe/slot type, some of resource D belongs to the GP, and the other of resource D belongs to the UL region.

In FIG. 6, resource E consists of resources that do not belong to the measurement bandwidth and do not belong to symbols for the fixed DL resource. The fixed DL resource and resource E may use different numerologies. In the case in which the GP is included in a subframe/slot type, some of resource E belongs to the GP, and the other of resource E belongs to the UL region.

RRM measurement applied to the 3GPP NR system is defined. An RRM metric may be defined as a function between a traffic load and an RSRP.

The RRM metric of the 3GPP NR system may not use the RSRP, the RSRQ, and the RS-SINR of the 3GPP LTE as they are in the 3GPP NR system. Since the DL NR-DRS resource includes the fixed DL resource, the terminal may measure the RSRP.

An RSSI measuring method for measuring the RSRQ will be described. A time boundary and a frequency boundary between resources used for measuring the RSSI are defined. The 3GPP NR system using several numerologies may define a boundary between symbols depending on a numerology used by the fixed DL resource. The measurement bandwidth defines a boundary between subcarriers on the basis of the numerology used in the fixed DL resource. In this case, two or more numerologies are used, and subcarriers located at a boundary of the measurement bandwidth are thus utilized for a guard band. Therefore, energy received in these subcarriers may not be reflected in a value of the RSSI.

For the purpose of the RS-SINR measurement, an SINR needs to be measured in the same RE as an RE for the RS. However, it is a resource limited within the fixed DL resource, and is thus a value measured regardless of a traffic load.

Energy measured in the RE and energy measured in the symbol need to be distinguished from each other. In the case of the RSRP measured in the DL NR-DRS resources, the terminal removes cyclic prefixes (CPs) from received symbols, and extracts subcarriers having the DL NR-DRS in the frequency domain. Then, the terminal constitutes a sequence using only the subcarriers having the DL NR-DRS. In addition, the terminal compares the constituted sequence with a DL NR-DRS sequence already known by the terminal to perform coherent detection. On the other hand, in the case in which energy detection is performed in the symbol, the terminal does not need to perform the coherent detection, and measures energy received within a time boundary of the symbol. Since only specific subcarriers are not separately processed, the terminal may also measure the energy measured in the symbol in the time domain.

In order to remove resources corresponding to specific REs from RSSI measurement resources, separate processing is required. For example, a case in which the REs including the DL NR-DRS resources are excluded from the RSSI measurement resources may be considered. The terminal removes cyclic prefixes (CPs) from the corresponding symbols, and extracts subcarriers having the DL NR-DRS in the frequency domain. The terminal calculates energy in the remaining subcarriers.

A unit for the RSSI measurement in the RSSI measurement resources is not the symbol, but may be the RE, and in the case in which the RSSI is measured in an RE unit, the method described above may be applied.

The RSRQ that may be applied to the 3GPP NR system may be defined as a function between the RSRP and the RSSI. As an example, the RSRQ may be determined as a ratio between the RSRP and the RSSI/N. Here, a value of N corresponds to the number of PRBs used by the terminal for the RSSI measurement. As another example, the RSRQ may be determined as a ratio between the RSRP and (RSRP+RSSI/N).

3GPP NR TDD reference systems 1, 2, and 3 may define several numerologies, and the TS may assign the fixed DL resources per numerology. In this case, when the terminal knows all the fixed DL resources, the terminal may perform the RRM measurement utilizing all of several fixed DL resources.

An RSSI measuring method (method RSSI0-1, method RSSI0-2, method RSSI0-3, and the like) for 3GPP NR cells will be described.

In method RSSI0-1, since 3GPP NR TDD reference system 1 may be operated in the dynamic TDD, a case in which the terminal may not know the corresponding subframe/slot type is assumed.

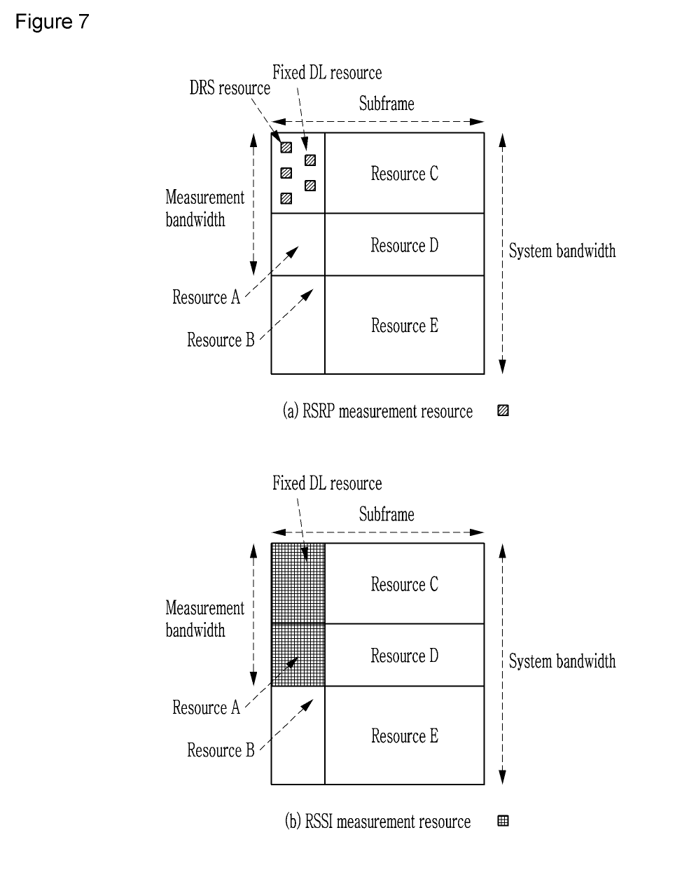

FIG. 7 is a view showing method RSSI0-1 according to an exemplary embodiment of the present invention. In detail, an RSRP measurement resource is shown in (a) of FIG. 7, and an RSSI measurement resource is shown in (b) of FIG. 7.

In method RSSI0-1, a case in which method IND1 and method IND2 are not used is assumed.

As shown in (a) of FIG. 7, an RSRP may be measured in an RE for the DL NR-DRS among REs belonging to the fixed DL resource. As shown in (b) of FIG. 7, an RSSI may be measured in a symbol (symbols) belonging to resource A and the fixed DL resource. That is, the RSSI may be measured in resources belonging to the symbol having the fixed DL resource and belonging to the measurement bandwidth. The terminal uses energy collected in all the symbols that may be known as the DL region for the RSSI.

However, the terminal may not accurately measure a DL traffic load of an NR cell by such a measuring method. Since the fixed DL resource transmits a physical signal and a physical channel necessary for a system operation rather than DL data, the RSSI over-estimates the DL traffic load. In addition, since the terminal measures the RSRP and the RSSI in different PRBs (for example, resource A), the RSSI may be subjected to a frequency response different from that of the RSRP depending on frequency selective fading, and the RSRP and the RSSI may be subjected to different DL interferences. On the other hand, the RSSI used for a 3GPP LTE RSRQ is a function of DL interference, and the RSRP and the RSSI are measured in the same band, and the RSSI is thus irrelevant to the frequency selective fading.

In the case in which 3GPP NR TDD reference system 2 and 3GPP NR TDD reference system 3 are operated in the dynamic TDD, an exemplary embodiment of the present invention may be applied.

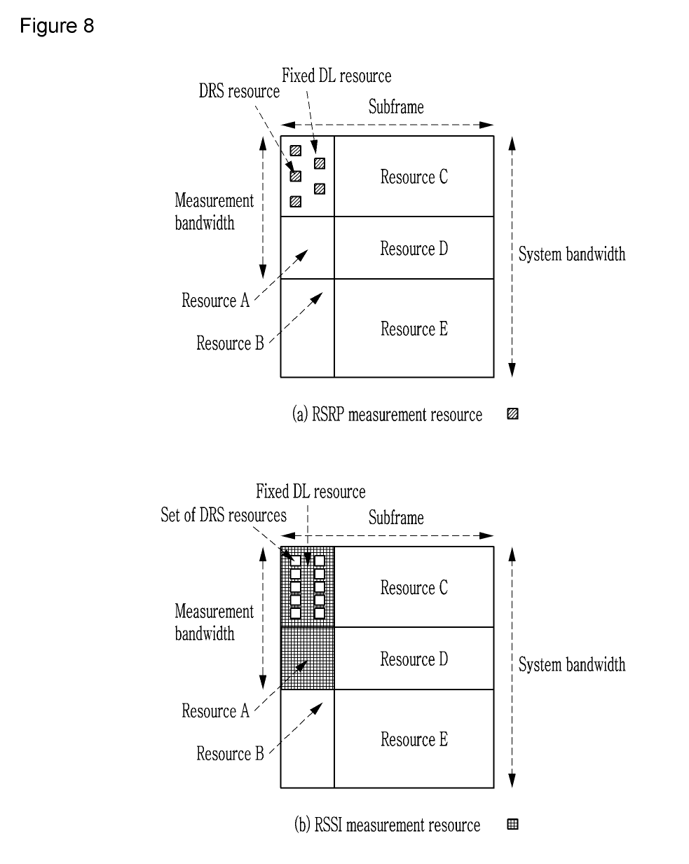

FIG. 8 is a view showing method RSSI0-1-1 according to an exemplary embodiment of the present invention. In detail, an RSRP measurement resource is shown in (a) of FIG. 8, and an RSSI measurement resource is shown in (b) of FIG. 8.

In method RSSI0-1-1 for method RSSI0-1, as shown in (a) of FIG. 8, an RSRP is measured in REs including the DL NR-DRS among REs belonging to the fixed DL resource.

In method RSSI0-1-1, as shown in (b) of FIG. 8, an RSSI is measured in symbols belonging to resource A and the fixed D resource, and is measured in subcarriers that do not include the DL NR-DRS.

The RSSI may be measured in the symbols or be measured in the REs. That is, the RSSI means subcarriers other than the DL NR-DRS resources among the subcarriers belonging to the symbol having the fixed DL resource. Here, the DL NR-DRS resources mean a collection of DL NR-DRS resources transmitted by each of the 3GPP NR cells. The terminal in the RRC idle (RRC_IDLE) state needs to detect the DL NR-DRS resources corresponding to some of an entire collection of DL NR-DRSs by oneself, and the terminal in the RRC connected (RRC_CONNECTED) state may be applied with the collection of DL NR-DRS resources configured from the serving base station or may detect some of the DL NR-DRS resources by oneself.

Since the terminal does not measure the RSSI in the DL NR-DRS resources, the RSSI measured by the terminal may include all of the PDCCH, the SIB, and the PDSCH of the NR cell.

In such an RSSI measuring method, both of a control channel load and a DL traffic load of the NR cell are measured in the terminal. Since the control channel load of the NR cell includes a DL scheduling assignment and a UL scheduling grant, the terminal may guess an amount of DL traffics and an amount of UL traffics. Accuracy of such a guess is low. Since beamforming and a CCE aggregation level of the PDCCH and beamforming of the PDSCH are different from each other, it is difficult that an interference condition is guessed. The amount of UL traffics may not be measured from the PUSCH, and may be indirectly guessed from an amount of PDCCHs.

In addition, resources having a numerology different from a numerology for the fixed DL resource among some of resource A may be assigned by the 3GPP NR cells. In this case, since separate PDCCHs may be assigned by the 3GPP NR cells, the RSSI measured in resource A reflects a control load as well as a data load. Here, since the control channel is transmitted to the terminal in the RRC connected (RRC_CONNECTED) state in most cases, beamforming of the control channel and beamforming of the data channel may not be significantly different from each other.

In the case in which 3GPP NR TDD reference system 2 and 3GPP NR TDD reference system 3 are operated in the dynamic TDD, an exemplary embodiment of the present invention may be applied.

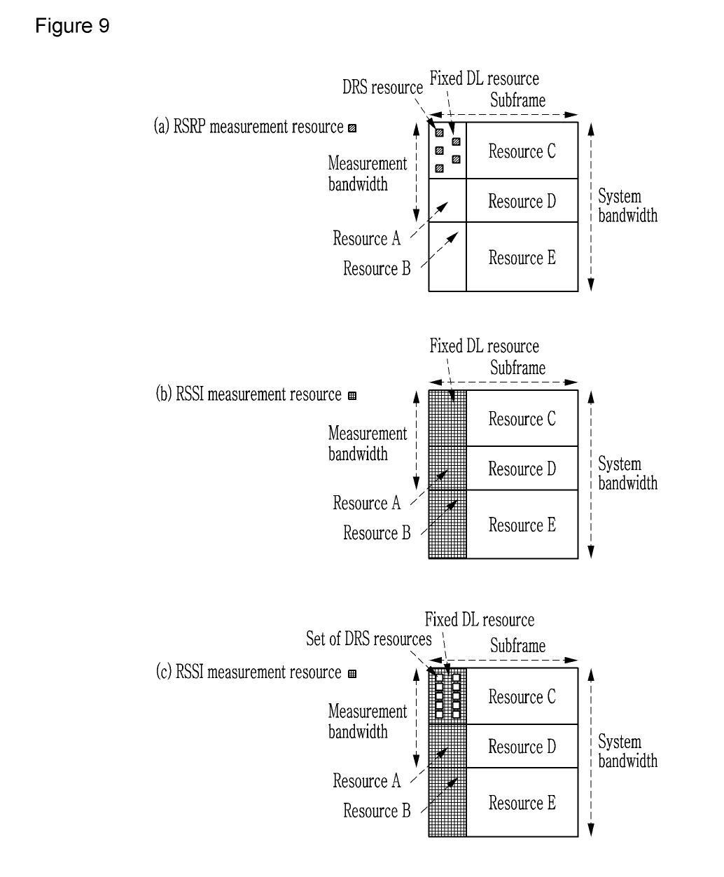

FIG. 9 is a view showing method RSSI0-1-2 according to an exemplary embodiment of the present invention. In detail, an RSRP measurement resource is shown in (a) of FIG. 9, and an RSSI measurement resource is shown in (b) and (c) of FIG. 9.

In method RSSI0-1-2 for method RSSI0-1, an RSRP is measured in REs including the DL NR-DRS among REs belonging to the fixed DL resource, and an RSSI is measured in symbols belonging to resource A, resource B, and the fixed DL resource.

The RSSI may be measured in a symbol level or be measured in an RE level. In the case in which the RSSI is measured in the REs, the RSSI may be measured in REs that do not include the DL NR-DRS. In (b) of FIG. 9, a case in which an RSSI is measured in an entire symbol (for example, a fixed DL resource, resource A, and resource B) is shown. In (c) of FIG. 9, a case in which an RSSI is measured in REs (for example, REs other than DL-NR DRS REs among REs belonging to a fixed DL resource, resource A, and resource B) that do not include a DL NR-DRS is shown.

According to such a method, the terminal may measure the RSSI in a symbol including the fixed DL resource regardless of the subframe/slot type.

In method RSSI0-2, a case in which 3GPP NR TDD reference system 1 is operated in the dynamic TDD and the terminal may know the subframe/slot type through method IND1 is assumed.

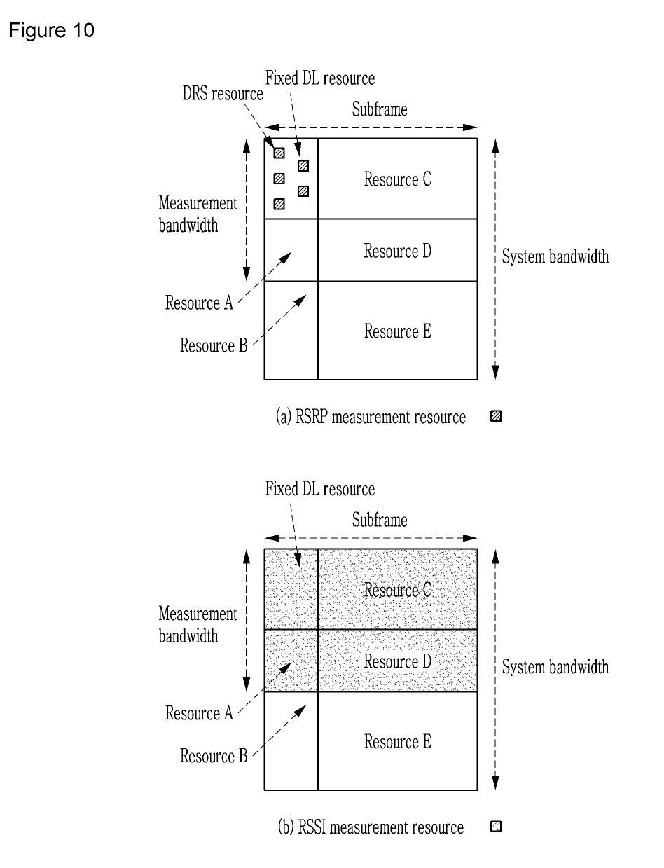

FIG. 10 is a view showing method RSSI0-2 according to an exemplary embodiment of the present invention. In detail, an RSRP measurement resource is shown in (a) of FIG. 10, and an RSSI measurement resource is shown in (b) of FIG. 10.

The terminal may divide resources corresponding to a DL region with respect to resource C and resource D. The RSSI may be measured in a symbol level or be measured in an RE level.

As shown in (a) of FIG. 10, the terminal measures the RSRP using DL NR-DRS resources belonging to the fixed DL resource.

As shown in (b) of FIG. 10, the terminal may measure the RSSI in the DL region belonging to a measurement bandwidth. That is, the terminal may measure the RSSI in the fixed DL resource, resource A, resource C, and resource D.

Such an RSSI measuring method may be simply implemented, but control channels or the DL NR-DRS resources included in the fixed DL resource do not appropriately reflect a traffic load.

The 3GPP NR cell may assign PDCCHs having different numerologies to resource A, resource C, and resource D in order to transfer a data scheduling assignment to the terminal in the RRC connected (RRC_CONNECTED) state. They do not correspond to a data load. However, they correspond to physical channels assigned in proportion to a cell load, and may thus be reflected in measuring the RSSI.

Since a PRB in which the RSSI is measured and a PRB in which the RSRP is measured are different from each other, frequency selectivity of channels may have an influence on the RSSI.

In the case in which 3GPP NR TDD reference system 2 and 3GPP NR TDD reference system 3 are operated in the dynamic TDD, an exemplary embodiment of the present invention may be applied. Resources corresponding to the DL region are extracted from resource C and resource D, and an exemplary embodiment of the present invention is applied to the extracted resources.

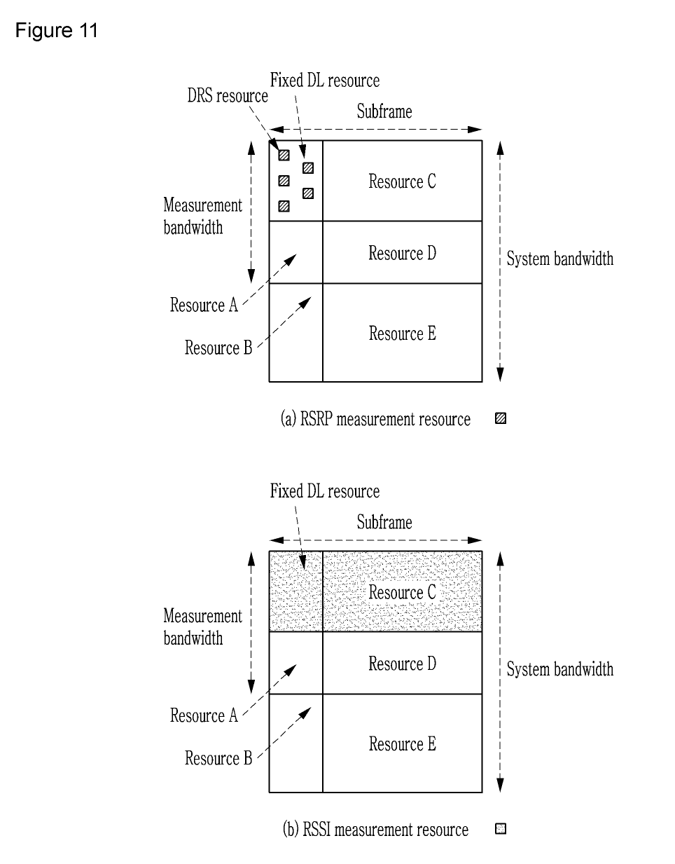

FIG. 11 is a view showing method RSSI0-2-1 according to an exemplary embodiment of the present invention. In detail, an RSRP measurement resource is shown in (a) of FIG. 11, and an RSSI measurement resource is shown in (b) of FIG. 11.

In method RSSI0-2-1 for method RSSI0-2, a case in which 3GPP NR TDD reference system 1 is operated in the dynamic TDD and the terminal may know the subframe/slot type through method IND1 is assumed.

The terminal may divide resources corresponding to a DL region with respect to resource C. The RSSI may be measured in a symbol level or be measured in an RE level.

As shown in (a) of FIG. 11, the terminal measures the RSRP using DL NR-DRS resources belonging to the fixed DL resource.

As shown in (b) of FIG. 11, the terminal may measure the RSSI in the fixed DL resource and resource C.

Since the terminal measures the RSRP and the RSSI in the same PRBs, channel frequency selectivities for the RSRP and the RSSI are equally reflected in calculation.

In the case in which 3GPP NR TDD reference system 2 and 3GPP NR TDD reference system 3 are operated in the dynamic TDD, an exemplary embodiment of the present invention may be applied. Resources corresponding to the DL region are extracted from resource C, and an exemplary embodiment of the present invention is applied to the extracted resources.

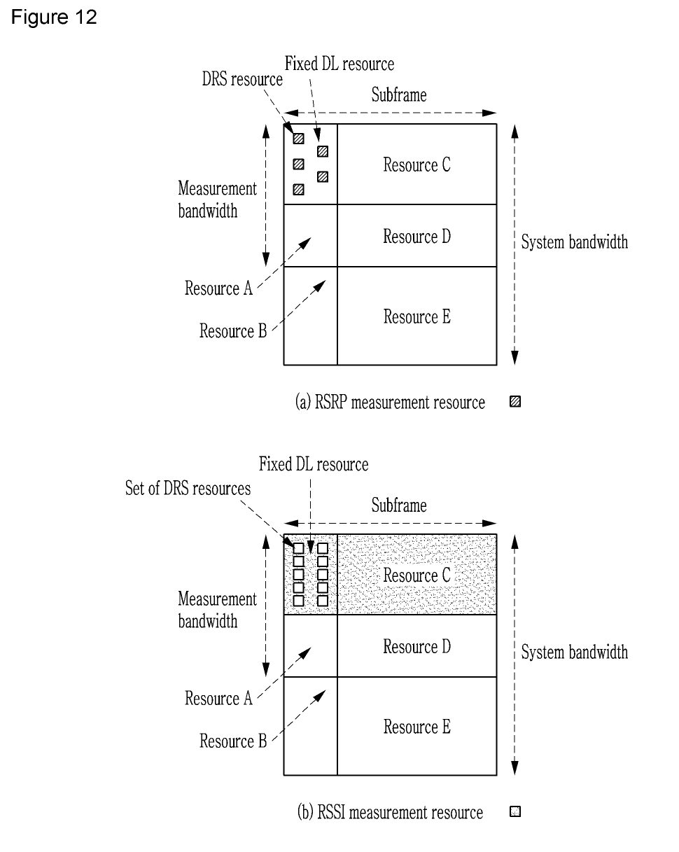

FIG. 12 is a view showing method RSSI0-2-2 for method RSSI0-2 according to an exemplary embodiment of the present invention. In detail, an RSRP measurement resource is shown in (a) of FIG. 12, and an RSSI measurement resource is shown in (b) of FIG. 12.

As shown in (a) of FIG. 12, the terminal may measure the RSRP using DL NR-DRS resources.

As shown in (b) of FIG. 12, the terminal may measure the RSSI in resources other than the DL NR-DRS resources among fixed DL resources.

When the terminal may extract a DL region within resource C using method IND2, the terminal utilizes the extracted DL region to measure the RSSI. When the terminal may not detect existence of a GP within resource C using method IND2, the terminal does not utilize resource C to measure the RSSI.

The RSSI may be measured in a symbol level or be measured in an RE level.

According to method IND2, in the case of a 3GPP NR terminal located at a boundary of a coverage, detection probability of a GP is reduced, and an amount of resources used for the RSSI is thus small. On the other hand, in the case of a 3GPP NR terminal located at the cell center, an amount of resources used for the RSSI is relatively larger. Therefore, in the case in which method IND2 is used, locations of the terminals have an influence on RSRQ measurement latency.

The resources utilized for the RSSI include at least the fixed DL resources, but do not include the DL NR-DRS resources. The terminal in the RRC idle (RRC_IDLE) state needs to detect the DL NR-DRS resources corresponding to some of an entire collection of NR-DRSs by oneself, and the terminal in the RRC connected (RRC_CONNECTED) state may be applied with the collection of DL NR-DRS resources configured from the serving base station or may detect some of the DL NR-DRS resources by oneself. In the RSSI measurement resources defined as described above, the PDCCH is included in the fixed DL resources and is periodically transmitted. Therefore, a DL data load is not accurately represented. Here, since the PDCCH is transmitted to the terminal in the RRC connected (RRC_CONNECTED) state in most cases, beamforming of the PDCCH and beamforming of the PDSCH may not be significantly different from each other. Therefore, in the case in which the DL data load is measured in the fixed DL resource, a physical channel and a physical signal having terminal-specific (for example, UE-specific) beamforming may be included in the fixed DL resource.

In the case in which 3GPP NR TDD reference system 2 and 3GPP NR TDD reference system 3 are operated in the dynamic TDD, an exemplary embodiment of the present invention may be applied. Resources corresponding to the DL region are extracted from resource C, and an exemplary embodiment of the present invention is applied to the extracted resources.

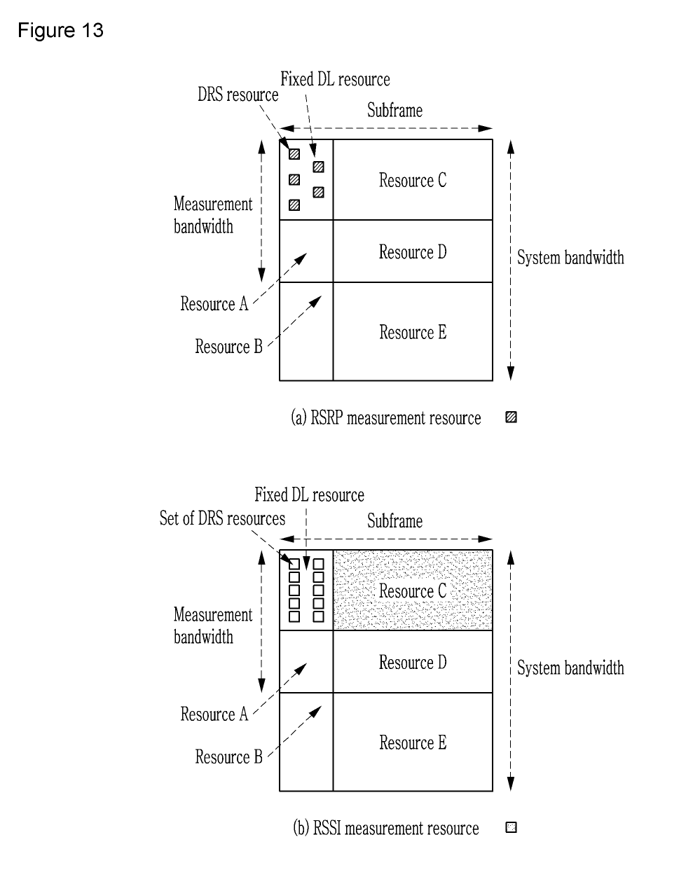

FIG. 13 is a view showing method RSSI0-2-3 according to an exemplary embodiment of the present invention. In detail, an RSRP measurement resource is shown in (a) of FIG. 13, and an RSSI measurement resource is shown in (b) of FIG. 13.

Method RSSI0-2-3 for method RSSI0-2 corresponds to a case in which 3GPP NR TDD reference system 1 is operated in the dynamic TDD and the NR cell uses method IND1, such that the terminal implicitly knows the subframe/slot type.

As shown in (a) of FIG. 13, the terminal measures the RSRP using DL NR-DRS resources.

As shown in (b) of FIG. 13, the terminal measures the RSSI in a DL region of resource C. The RSSI may be measured in a symbol level or be measured in an RE level.

In the case in which the 3GPP NR cells use several numerologies, several numerologies may be applied to resource C. To this end, the 3GPP NR cells may assign separate control channels to resource C. Therefore, in the case in which the terminal measures the RSSI using resource C, the terminal measures a control load and a data load together. Since such a PDCCH indicates a scheduling assignment or a UL scheduling grant to the terminal in the RRC connected (RRC_CONNECTED) state, beamforming of the PDCCH is performed so as not to be significantly different from beamforming of the PDSCH. The terminal may measure the DL load to some degrees through the RSSI.

In the case in which 3GPP NR TDD reference system 2 and 3GPP NR TDD reference system 3 are operated in the dynamic TDD, an exemplary embodiment of the present invention may be applied. Resources corresponding to the DL region are extracted from resource C, and an exemplary embodiment of the present invention is applied to the extracted resources. Method RSSI0-3 corresponds to a case in which 3GPP NR TDD reference system 1, 3GPP NR TDD reference system 2, and 3GPP NR TDD reference system 3 are operated in the dynamic TDD.

According to method RSSI0-3, the terminal measures the RSRP using the DL NR-DRS resources (for example, (a) of FIG. 13), and measures the RSSI in resource C (for example, (b) of FIG. 13). The RSSI may be measured in a symbol level or be measured in an RE level.

The 3GPP NR cell may utilize resource C for any subframe/slot type. On the other hand, the terminal utilizes all of the symbols belonging to resource C and belonging to the measurement bandwidth as RSSI measurement resources regardless of the subframe/slot type. Such a method corresponds to an adding-up method irrelevant (or equal) to a DL load and a UL load.

A utilization method for a case in which the terminal measures the UL load is as follows. In the case in which the terminal in the RRC idle (RRC_IDLE) state generates a UL traffic corresponding to a URLLC service, a UL traffic load is reflected in the RRM measurement so as to be associated with an NR cell having a small UL traffic load. In this case, control plane latency may be reduced.

There is a case in which proximity between terminals has an influence on the UL traffic load. There is a case in which a terminal performing the RRM measurement, of two terminals geographically adjacent to each other, is operated as a victim and the other terminal receiving a UL scheduling grant and transmitting the UL data is operated as an aggressor. In this case, since a distance between the terminals is short, even though the UL traffic load is small, the RSSI is over-estimated. However, in the case in which the UL traffic load is continuously generated enough to have an influence on the RSSI measurement, the two terminals are geographically adjacent to each other, such that it is difficult that a UL resource region is spatial-division-multiplexed (SDM), and the UL resource region needs to be time-division-multiplexed (TDM) or frequency division multiplexed (FDM). In this case, control plane latency for receiving the UL scheduling grant is large.

The serving base station may configure the RRM measurement for an inter-frequency with respect to the terminal. In the case in which the terminal does not have a sufficient number of receiver units (R×Us), the serving base station configures a measurement gap with respect to the terminal, and the terminal may measure the RSRP, the RSRQ, or the RSRP and the RSRQ with respect to cells (or base stations) belonging to the inter-frequency using the measurement gap. The configuration of the measurement gap includes at least a measurement gap length, a measurement gap repetition period, and a subframe offset (or a slot offset) possessed by a first subframe (or a first slot belonging to the measurement gap.

A specific frequency, a specific base station, and the like, measured by the terminal in the measurement gap are not configured by the serving base station, and are selected by the terminal depending on an implementation algorithm of the terminal. The serving base station needs to configure an appropriate measurement gap with respect to the terminal so that the terminal may accomplish sufficient RRM measurement accuracy within a predetermined time.

The serving base station configures the measurement gap with respect to the terminal, and the terminal measures a signal and a physical channel belonging to a specific frequency within the measurement gap. For example, such a signal includes at least a primary synchronization signal (PSS), a secondary synchronization signal (SSS), an RRM signal (hereinafter, referred to as an ‘RRS’), and a PBCH DM-RS, and may also include a DL NR-DRS. In addition, such a physical channel includes at least a broadcasting channel (for example, a PBCH).

The serving base station may treat the primary synchronization signal, the secondary synchronization signal, and the broadcasting channel as one transmission unit and sequentially transmit one or more transmission units depending on a time. For example, such a transmission unit is called an SS burst in the NR, and the maximum number of SS bursts depending on a frequency band in which the serving base station is operated is defined in the specification. The serving base station actually transmits SS bursts of which the number is less than the maximum number, and a periodicity in which the SS bursts are transmitted is defined in the specification.

However, in the case in which the serving base station configures a measurement gap with respect to a specific terminal, a periodicity in which the SS bursts are transmitted and slot offsets may be transmitted by the serving base station. Here, the periodicity in which the SS bursts are transmitted and the slot offsets may have values selected by the serving base station among values that are not defined in the specification as well as values that are defined in the specification.

Since the terminal uses the measurement gap in order to perform the RRM measurement for the inter-frequency, the serving base station and the neighboring base stations may transmit the SS bursts in slots belonging to the corresponding measurement gap. Since the terminal may not receive the SS bursts in the measurement gap, the serving base station may configure the measurement gap and a measurement frequency with respect to the terminal. For example, the serving base station separately configures one or more measurement gaps with respect to the terminal, and configures the respective measurement gaps to be associated with specific frequency bands. Therefore, configuration information of the measurement gaps includes at least frequency resources that need to be measured by the terminal in slots belonging to the corresponding measurement gaps as well as a periodicity of the measurement gaps and slot offsets. The frequency resources may be represented by relative indices (for example, cell indices, or the like) or be represented by absolute indices (for example, frequency identification information, or the like). Here, the frequency identification information may be an absolute radio-frequency channel number (ARFCN).

The terminal performs measurement in the slots belonging to the measurement gap and the measurement frequency. Here, a physical amount measured by the terminal may be the RSRP, the RSRQ, the RS-SINR, or any combination thereof, depending on a configuration of the serving base station.

In the case in which the base stations are operated in the dynamic TDD at the measurement frequency, a scenario in which the terminal needs to measure the RSRQ is considered. In this case, the terminal receives common search spaces (CSSs) of the PSTICHs or the PDCCHs from the respective base stations, and recognizes the STIs on the basis of the CSSs. The terminal deduces a DL region using the STIs, and then measures the RSRQ.

A case in which the base stations are beam-centrically operated at the measurement frequency to treat a primary synchronization signal and a secondary synchronization signal as one unit (for example, an SS burst) and several such units are transmitted to constitute an SS burst set is considered. It is assumed that the terminal may observe the SS bursts during at least one periodicity within the measurement gap, and it is assumed that the base station applies the same precoding to signals belonging to one SS burst. The terminal performs the RRM measurement using RRS resources belonging to the SS bursts, and deduces different RRM measurements per precoding. For example, when one serving base station transmits four SS bursts, the terminal assumes that four different precodings exist, distinguishes RRS resources belonging to the respective SS bursts from each other, and performs four RRM measurements. The terminal configured to perform the RSRP measurement may deduce four

RSRPs, and the terminal configured to perform the RSRQ measurement may deduce four RSRQs.

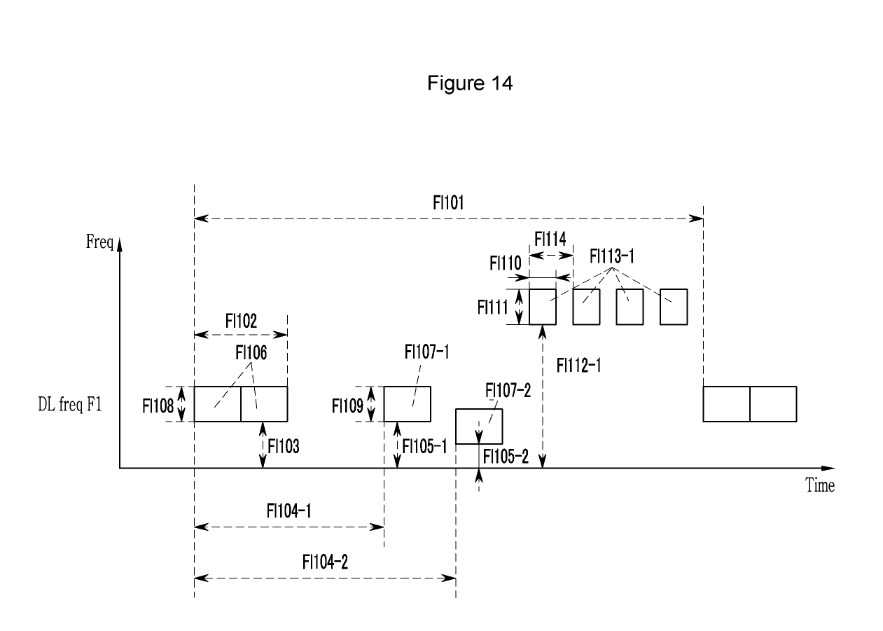

FIG. 14 is a view showing transmission of a new radio-system information block (NR-SIB) according to an exemplary embodiment of the present invention. In detail, a case in which method C2-2 is used is shown in FIG. 14.

In FIG. 14, FI101 indicates a periodicity of an NR-subframe/slot in which DL NR-DRSs are transmitted. In the NR-subframe/slot in which the DL NR-DRSs are transmitted, one or more DL NR-DRS resources are transmitted. One DL NR-DRS resource corresponds to a virtual sector of the base station. As a periodicity of the DL NR-DRS, a value defined by the specification may be used.

In FIG. 14, FI102 indicates a DL NR-DRS occasion duration. The base station may transmit the DL NR-DRS resources in consecutive and valid DL NR-subframes/slots. The DL NR-DRS occasion duration is to extend a DL coverage. Since the base station transmits the NR-PBCH on the basis of the DL NR-DRS antenna port, the base station may transmit the corresponding DL NR-PBCH in the DL NR-DRS occasion duration. The base station may configure a value of the DL NR-DRS occasion duration with respect to the terminal through higher layer signaling. In the case in which separate signaling does not exist from the base station, the terminal estimates the value of the DL NR-DRS occasion duration through blind detection.

In FIG. 14, FI103 indicates a frequency resource including a DL NR-DRS and an NR-PBCH. For example, FI103 may be represented by an NR-RB index or be represented by a combination of subband index and NR-RB index.

In FIG. 14, FI104-1 indicates a location of a time resource possessed by a UL NR-DRS resource. The terminal estimates FI104-1 from an NR-PBCH transmitted by virtual sector 1 of the base station. The time resource, which is a relative value based on a first NR-subframe/slot belonging to the DL NR-DRS occasion duration, may be defined as an NR-subframe/slot offset or a symbol offset. Alternatively, the time resource, which is an absolute value of an NR-subframe/slot to which a UL NR-DRS resource belongs, may be defined as an NR-subframe/slot index. As an example, a transmission point in time of the UL NR-DRS resource may be a symbol belonging to the same NR-subframe/slot as that of a transmission point in time of the DL NR-DRS resource. In this case, a location of the time resource corresponds to the symbol offset. As another example, the UL NR-DRS resource may be configured in a separate NR-subframe/slot. In this case, a location of the time resource corresponds to the NR-subframe/slot offset.

In FIG. 14, FI104-2 indicates a location of a time resource possessed by a UL NR-DRS resource. The terminal estimates FI104-2 from an NR-PBCH transmitted by virtual sector 2 of the base station. FI104-2 has the same meaning as that of FI104-1.

In the case in which the base station transmits one or more virtual sectors, several UL NR-DRS resources may be configured.

In FIG. 14, FI105-1 indicates a location of a frequency resource possessed by a UL NR-DRS resource. The terminal estimates FI105-1 from an NR-PBCH transmitted by virtual sector 1 of the base station. For example, FI105-1 may be represented by an NR-RB index or be represented by a combination of subband index and NR-RB index.

In FIG. 14, FI105-2 indicates a location of a frequency resource possessed by a UL NR-DRS resource. The terminal estimates FI105-2 from an NR-PBCH transmitted by virtual sector 2 of the base station. FI105-2 has the same meaning as that of FI105-1.

In FIG. 14, FI106 indicates a radio resource including a DL NR-DRS and an NR-PBCH.

In FIG. 14, FI107-1 indicates a radio resource including a UL NR-DRS. In the case in which the terminal selects virtual sector 1, the terminal may transmit the UL NR-DRS using FI107-1.

In FIG. 14, FI107-2 indicates a radio resource including a UL NR-DRS. In the case in which the terminal selects virtual sector 2, the terminal may transmit the UL NR-DRS using FI107-2.

In FIG. 14, FI108 indicates a bandwidth in which a DL NR-DRS resource and an NR-PBCH are assigned. As FI108, a value defined by the specification may be used.

In FIG. 14, FI109 indicates a bandwidth in which a UL NR-DRS resource is assigned. The terminal uses FI109 as a value defined by the specification or uses FI109 as a value configured by the NR-PBCH transmitted by the base station.

In FIG. 14, FI110 indicates an amount of time resources in which an NR-PDCCH is allocated. The terminal uses FI110 as a value defined by the specification or uses FI110 as a value configured by the NR-PBCH transmitted by the base station. As an example, the NR-PDCCH may be defined as the number of symbols. As another example, the NR-PDCCH may be defined as a unit of NR-subframe/slot.

In FIG. 14, FI111 indicates a bandwidth in which an NR-PDCCH is allocated. The terminal uses FI111 as a value defined by the specification or uses FI111 as a value configured by the NR-PBCH transmitted by the base station.

In FIG. 14, FI112-1 indicates a frequency location of an NR-PDCCH resource transmitted by virtual sector 1 of the base station. The base station may configure frequency locations of separate NR-PDCCH resources with respect to other virtual sectors. Alternatively, the base station may configure frequency locations of NR-PDCCH resources to be the same as each other regardless of virtual sector indices. Alternatively, frequency locations of NR-PDCCH resources may be defined by the specification.

In FIG. 14, FI113-1 indicates an NR-PDCCH resource transmitted by virtual sector 1 of the base station.

In FIG. 14, FI114 indicates a periodicity in which a NR-PDCCH is transmitted. In the case in which the NR-PDCCH is transmitted in a symbol unit, the NR-PDCCH appears per difference between first symbols in which the NR-PDCCH is assigned. In the case in which the NR-PDCCH is transmitted in an NR-subframe/slot unit, the NR-PDCCH appears per difference between NR-subframes/slots.

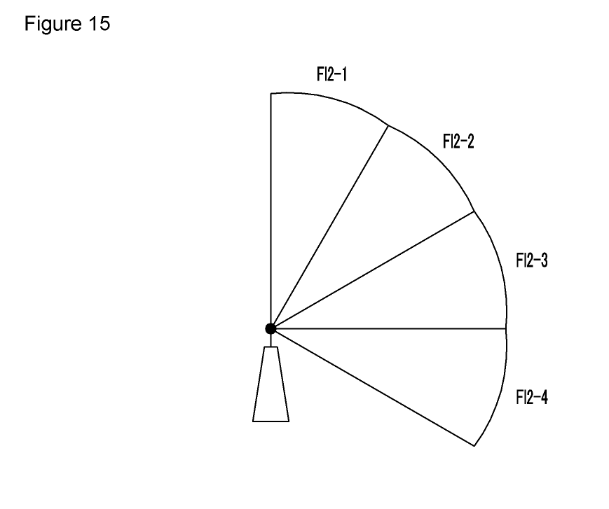

FIG. 15 is a view showing virtual sectors of a base station according to an exemplary embodiment of the present invention. A cell of the base station may be virtually subdivided into a plurality of virtual sectors. In detail, four virtual sectors FI2-1, FI2-2, FI2-3, and FI2-4 are shown in FIG. 15.

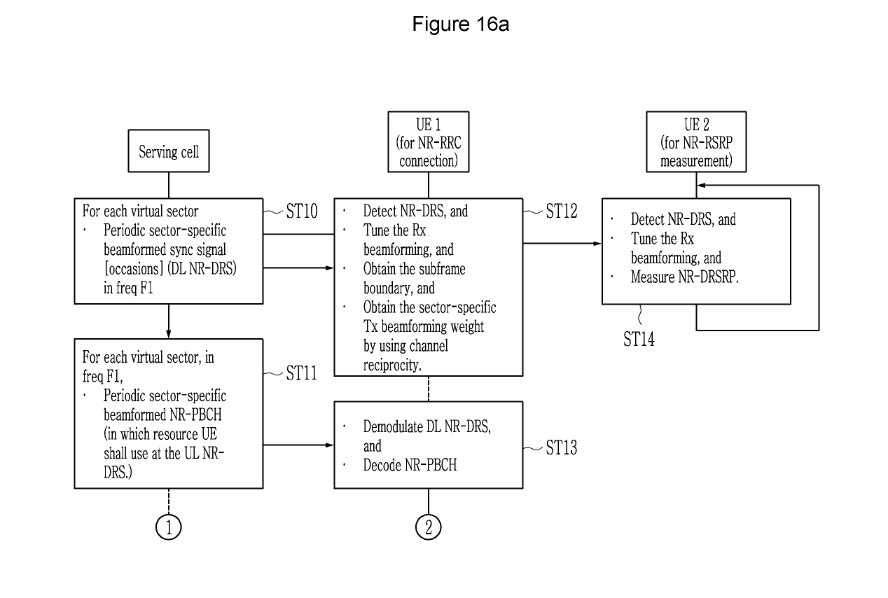

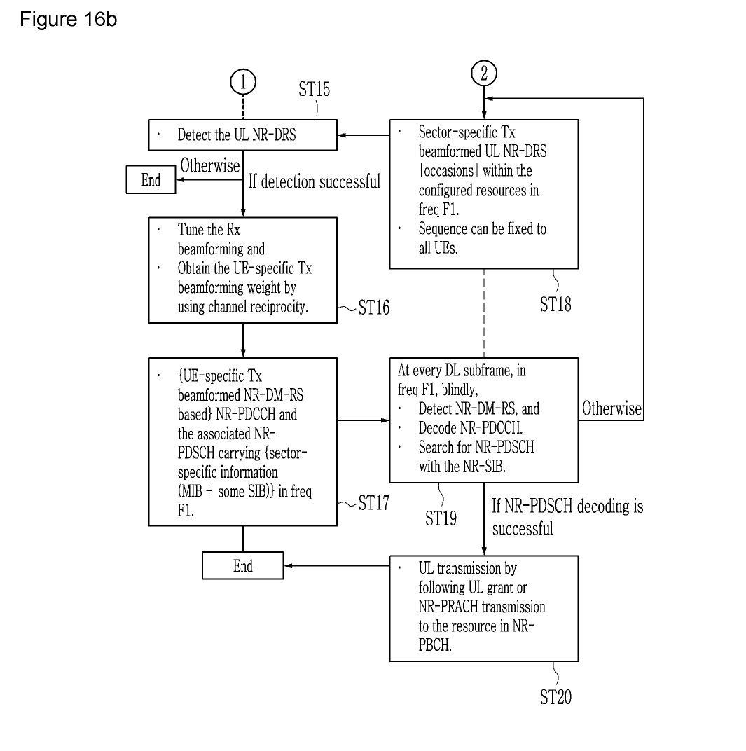

FIG. 16a and FIG. 16b are views showing procedures in which a base station (or a serving cell) transmits an NR-SIB to a terminal according to an exemplary embodiment of the present invention. In FIG. 16a, an NR-DRSRP means an RSRP based on an NR-DRS. Procedures (ST10 to ST20) shown in FIG. 16a and FIG. 16b may be applied to a case in which method R2 and method C1 (or method C2) are used.

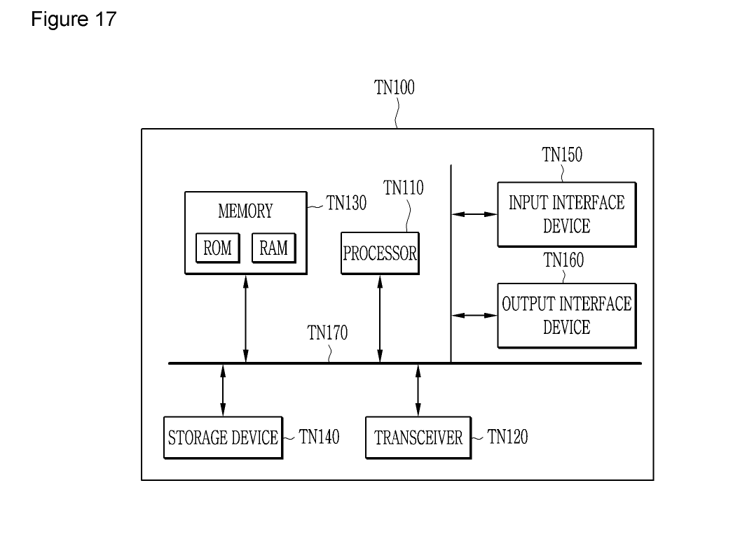

FIG. 17 is a view showing a computing apparatus according to an exemplary embodiment of the present invention. A computing apparatus TN100 of FIG. 17 may be the base station, the terminal, or the like, stated in the present specification. Alternative, the computing apparatus TN100 of FIG. 17 may be a wireless device, a communication node, a transmitter, or a receiver.

In an exemplary embodiment of FIG. 17, the computing apparatus TN100 may include at least one processor TN110, a transceiver TN120 connected to a network and performing communication, and a memory TN130. In addition, the computing apparatus TN100 may further include a storage device TN140, an input interface device TN150, an output interface device TN160, and the like. The components included in the computing apparatus TN100 may be connected to each other by a bus TN170 to perform communication with each other.

The processor TN110 may execute a program command stored in at least one of the memory TN130 and the storage device TN140. The processor TN110 may be a central processing unit (CPU), a graphics processing unit (GPU), or a dedicated processor in which the methods according to an exemplary embodiment of the present invention are performed. The processor TN110 may be configured to implement the procedures, the functions, and the methods stated in an exemplary embodiment of the present invention. The processor TN110 may control the respective components of the computing apparatus TN100.

Each of the memory TN130 and the storage device TN140 may store various kinds of information related to the operations of the processor TN110. Each of the memory TN130 and the storage device TN140 may be formed of at least one of a volatile storage medium and a non-volatile storage medium. For example, the memory TN130 may be formed of at least one a read only memory (ROM) and a random access memory (RAM).

The transceiver TN120 may transmit or receive wired signals or wireless signals. In addition, the computing apparatus TN100 may have a single antenna or multiple antennas.

Meanwhile, an exemplary embodiment of the present invention described above is not implemented through only the apparatus and/or the method described above, but may also be implemented through programs executing functions corresponding to configurations of an exemplary embodiment of the present invention, a recording medium in which the programs are recorded, and the like. In addition, these implementations may be easily made by those skilled in the art to which the present invention pertains from the exemplary embodiment described above.

Although the exemplary embodiment of the present invention has been described in detail hereinabove, the scope of the present invention is not limited thereto. That is, several modifications and alterations made by a person of ordinary skill in the art using a basic concept of the present invention as defined in the claims fall within the scope of the present invention.

1.-20. (canceled)

21. A transmission method of a base station, the transmission method comprising:
transmitting a first physical broadcast channel (PBCH) including first virtual sector index information and a second PBCH including second virtual sector index information;
receiving a first random access preamble from a first terminal through a first uplink resource corresponding to the first PBCH; and
transmitting to the first terminal a first random access response message for the first random access preamble based on the first virtual sector index information corresponding to the first uplink resource.

22. The transmission method according to claim 21, wherein a location of the first uplink resource is determined based on the first virtual sector index information.

23. The transmission method according to claim 22, wherein the base station detects the first virtual sector index information from information on the location of the first uplink resource through which the first random access preamble is received.

24. The transmission method according to claim 21, further comprising:
receiving a second random access preamble from a second terminal through a second uplink resource corresponding to the second PBCH; and
transmitting to the second terminal a second random access response message for the second random access preamble based on the second virtual sector index information corresponding to the second uplink resource.

25. The transmission method according to claim 24, wherein a location of the second uplink resource is determined based on the second virtual sector index information, and the base station detects the second virtual sector index information from information on the location of the second uplink resource through which the second random access preamble is received.

26. The transmission method according to claim 21, wherein the first PBCH includes information indicating whether a system information block (SIB) is transmitted or not.

27. The transmission method according to claim 26, wherein the first terminal monitors a physical downlink control channel (PDCCH) for scheduling the SIB when the SIB is indicated to be transmitted, and the first terminal does not monitor the PDCCH for scheduling the SIB when the SIB is indicated not to be transmitted.

28. The transmission method according to claim 26, wherein the SIB includes a system frame number (SFN), a system bandwidth, a physical layer cell identification information, or scheduling information of system information.

29. The transmission method according to claim 26, wherein the first PBCH includes-configuration information on a physical downlink control channel (PDCCH) for scheduling the SIB.

30. The transmission method according to claim 29, wherein the configuration information on the PDCCH is resource block (RB) index information of the PDCCH or bandwidth information of the PDCCH.

31. The transmission method according to claim 29, wherein the first PBCH includes information on a demodulation reference signal (DMRS) antenna port required for decoding the PDCCH.

32. A reception method of a first terminal, the reception method comprising:
receiving from a base station a first physical broadcast channel (PBCH) including first virtual sector index information and a second PBCH including second virtual sector index information;
comparing a reception quality of the first PBCH with a reception quality of the second PBCH;
in response to determining that the reception quality of the first PBCH is superior to the reception quality of the second PBCH, transmitting to the base station a first random access preamble through a first uplink resource corresponding to the first PBCH; and
receiving a first random access response message for the first random access preamble from the base station,
wherein the first random access response message is transmitted by the base station based on the first virtual sector index information corresponding to the first uplink resource.

33. The reception method according to claim 32, wherein the first terminal decodes a PBCH payload by combining the first PBCH and the second PBCH.

34. A reception method of a first terminal, the random access, method comprising:
receiving from a base station a first physical broadcast channel (PBCH) including first virtual sector index information and a second PBCH including second virtual sector index information;
transmitting a first random access preamble to the base station through a first uplink resource corresponding to the first PBCH; and
receiving from the base station a first random access response message for the first random access preamble based on the first virtual sector index information corresponding to the first uplink resource.

35. The reception method according to claim 34, wherein a location of the first uplink resource is determined based on the first virtual sector index information.

36. The reception method according to claim 35, wherein the base station detects the first virtual sector index information from information on the location of the first uplink resource through which the first random access preamble is received.

37. The reception method according to claim 34, wherein the first PBCH includes information indicating whether a system information block (SIB) is to be transmitted as scheduled by a physical downlink control channel (PDCCH) or not.

38. The reception method according to claim 37, wherein the first terminal monitors the PDCCH for scheduling the SIB when the SIB is indicated to be transmitted, and the first terminal does not monitor the PDCCH for scheduling the SIB when the SIB is indicated not to be transmitted.

39. The reception method according to claim 37, wherein the first PBCH includes information on a location of the PDCCH for scheduling the SIB.

40. The reception method according to claim 39, wherein the information on the location of the PDCCH is resource block (RB) index information of the PDCCH or bandwidth information of the PDCCH.
